(19) United States
(12) Patent Application Publication
(10) Pub. No.: US 2024/0416557 A1
(43) Pub. Date: Dec. 19, 2024

(54) Cutting Device of Silicon Rod Cutting System, and Silicon Rod Cutting System

(71) Applicant: QINGDAO GAOCE TECHNOLOGY CO., LTD, Qingdao, Shandong (CN)

(72) Inventors: Shengen HOU, Qingdao, Shandong (CN); Cong ZHOU, Qingdao, Shandong (CN); Kecun LIU, Qingdao, Shandong (CN); Changkun FAN, Qingdao, Shandong (CN); Peng SUN, Qingdao, Shandong (CN); Shifeng GUO, Qingdao, Shandong (CN)

(21) Appl. No.: 18/706,514

(22) PCT Filed: Oct. 26, 2022
(86) PCT No.: PCT/CN2022/127599

§ 371 Date: May 1, 2024

(30) Foreign Application Priority Data
Nov. 1, 2021 (CN) 202111285314.7

(51) Int. Cl. B28D 5/04; B28D 5/00

(52) U.S. Cl. CPC B28D 5/045; B28D 5/0076; B28D 5/0082

(57) ABSTRACT

A cutting device of a silicon rod cutting system, and the silicon rod cutting system. The cutting device includes: a support frame, installed on a machine base of the silicon rod cutting system; two cutting machine head mechanisms, wherein each cutting machine head mechanism is provided with a diamond wire, a cutting segment of the diamond wire is used for cutting a silicon rod from top to bottom while moving; and a feeding mechanism, wherein the support frame is connected with the two cutting machine head mechanisms by means of the feeding mechanism, and the two cutting segments are disposed opposite to each other; and the feeding mechanism is used for driving the two cutting machine head mechanisms to move towards and away from each other, so as to adjust the distance between the two cutting segments.

### CROSS-REFERENCE TO RELATED APPLICATION

The disclosure is a national stage application of International Patent Application No. PCT/CN2022/127599, which is filed on Oct. 26, 2022, and claims the priority to patent application No. 202111285314.7, entitled “Cutting Device of Silicon Rod Cutting System, and Silicon Rod Cutting System”, and filed to the Chinese Patent Office on Nov. 1, 2021.

### TECHNICAL FIELD

The present disclosure relates to the technical field of silicon rod cutting, and in particular to a cutting device of a silicon rod cutting system, and the silicon rod cutting system.

### BACKGROUND

At present, with the emphasis and openness of the utilization of green renewable energy sources in the society, the field of photovoltaic solar power generation has attracted more and more attention and development. In the field of photovoltaic power generation, a typical crystalline silicon solar cell is manufactured on a high-quality silicon wafer, and the silicon wafer is prepared by cutting a silicon rod, which has been subjected to pulling or casting, with a wire saw, that is, a line cutting technology.

The line cutting technology is a more advanced squaring processing technology in the world at present, and its principle is to rub a workpiece to be processed (for example, a silicon rod, sapphire, or other semiconductor hard and brittle materials) by means of a diamond wire moving at a high speed, so as to cut a square rod, thereby achieving the purpose of cutting. Compared with traditional blade saw blades, grinding wheel blades and inner circle cutting technologies, the line cutting technology has the advantages of high efficiency, high productivity, high precision, etc.

### SUMMARY

### Technical Problem

Existing silicon rod cutting systems have not been able to meet the requirements of the photovoltaic industry for silicon wafers.

### Solution of the Problem

### Technical Solution

Embodiments of the present disclosure provide a cutting device of a silicon rod cutting system having a new structure, and the silicon rod cutting system.

According to a first aspect of the embodiments of the present disclosure, provided is a cutting device of a silicon rod cutting system, including:
a support frame, installed on a machine base of the silicon rod cutting system;
two cutting machine head mechanisms, wherein each cutting machine head mechanism is provided with a diamond wire, a cutting segment of the diamond wire is used for cutting a silicon rod from top to bottom while moving; and
a feeding mechanism, wherein the support frame is connected with the two cutting machine head mechanisms by means of the feeding mechanism, and the two cutting segments are disposed opposite to each other; and
the feeding mechanism is used for driving the two cutting machine head mechanisms to move towards and away from each other, so as to adjust the distance between the two cutting segments, and the feeding mechanism is further used for driving the two cutting machine head mechanisms to move up and down in a vertical direction, so as to cut and reset a vertically disposed silicon rod.

According to a second aspect of the embodiments of the present disclosure, provided is a silicon rod cutting system, including the above cutting device.

### Beneficial Effects of the Invention

### Beneficial Effects

Since the above technical solutions are utilized, the embodiments of the present disclosure have the following technical effects: under the driving of the feeding mechanism, the two cutting machine head mechanisms of the same cutting device may move close to and away from each other in a transverse direction, so that the distance between the cutting segments of the two cutting machine head mechanisms of the same cutting device can be adjusted. That is, the two cutting segments of the same cutting machine head mechanism are disposed in parallel, and the distance between the two cutting segments is adjustable. Therefore, the cutting device can be applicable to vertically cutting silicon rods of various diameters, so that the universality of the cutting device is very high.

### BRIEF DESCRIPTION OF THE DRAWINGS

### Description of the Drawings

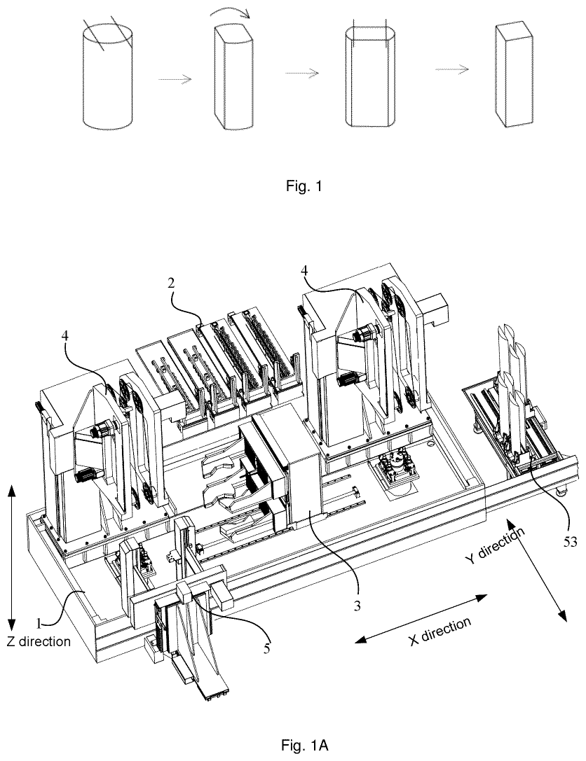

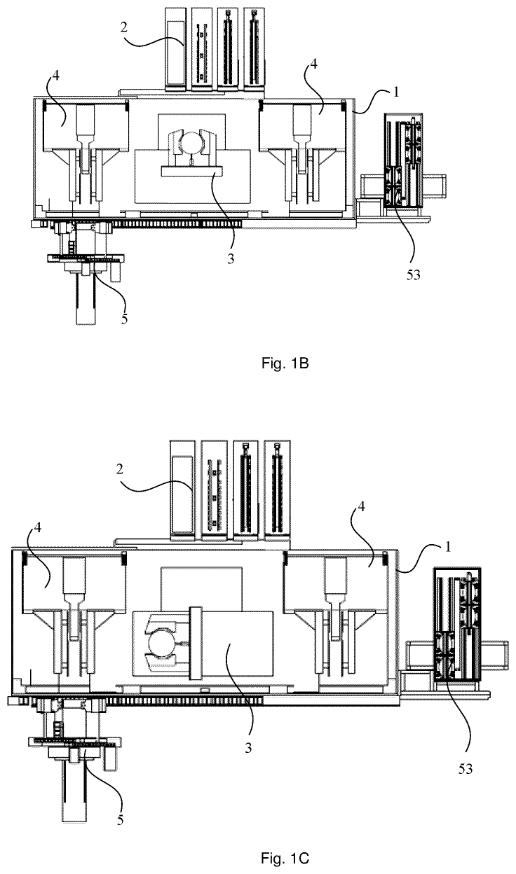

FIG. 1 illustrates a schematic diagram of a cutting process of a silicon rod cutting system according to an embodiment of the present disclosure;

FIG. 1A illustrates a schematic diagram of a silicon rod cutting system according to an embodiment of the present disclosure;

FIG. 1B and FIG. 1C illustrate schematic diagrams of a transfer device of the silicon rod cutting system shown in FIG. 1A when transferring a round silicon rod from a feeding and blanking device to a cutting device;

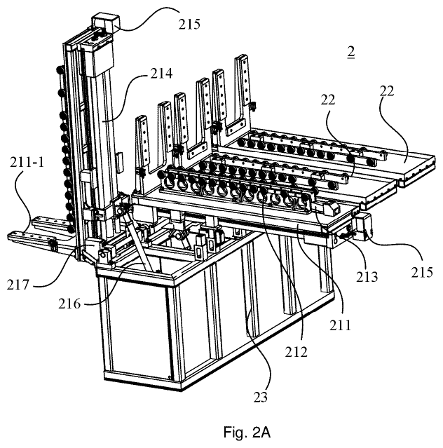

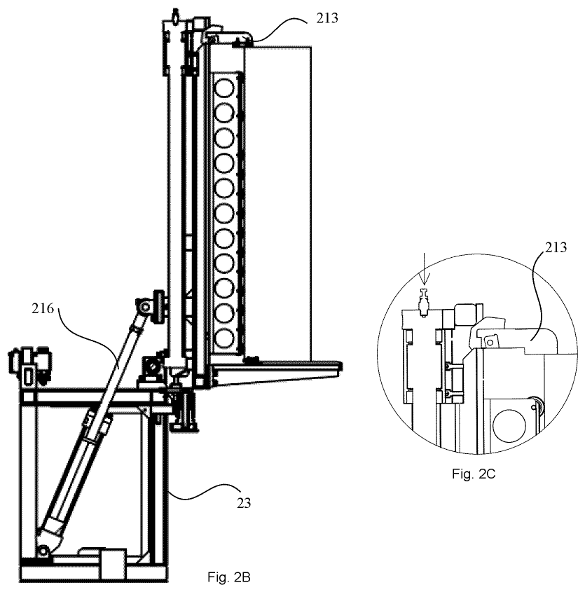

FIG. 2A illustrates a schematic diagram of a feeding and blanking device of a silicon rod cutting system according to an embodiment of the present disclosure;

FIG. 2B illustrates a schematic diagram of another angle of FIG. 2A;

FIG. 2C illustrates a partial enlarged view of FIG. 2B;

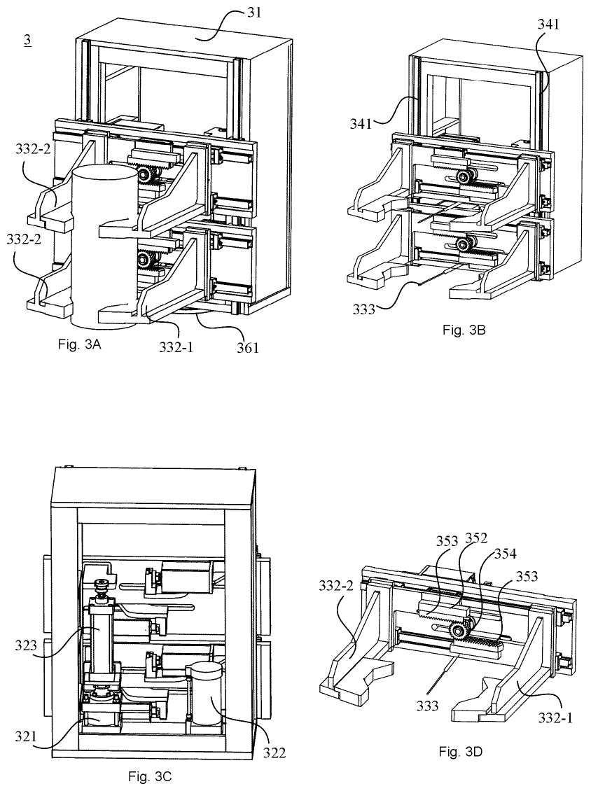

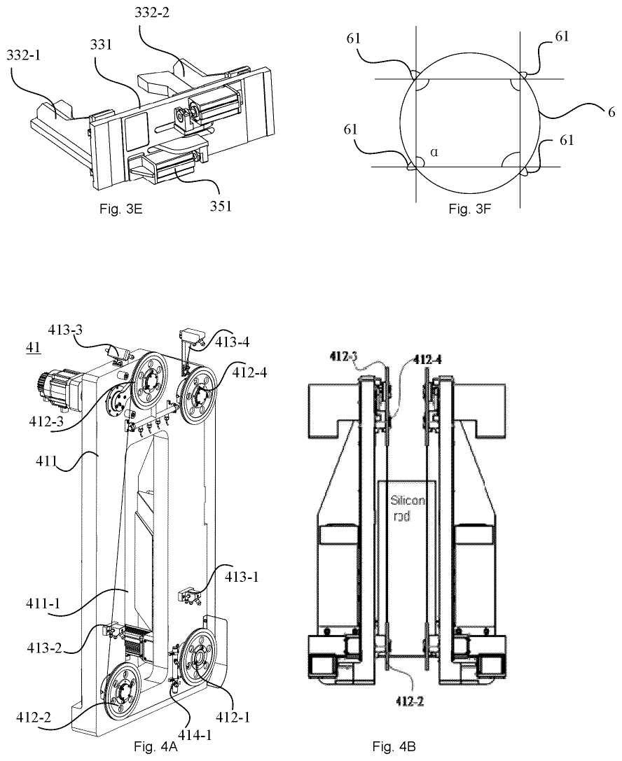

FIG. 3A, FIG. 3B and FIG. 3C are schematic diagrams of a transfer device of a silicon rod cutting system according to an embodiment of the present disclosure;

FIG. 3D and FIG. 3E are schematic diagrams of an upper clamping jaw assembly and a lower clamping jaw assembly of the transfer device of FIG. 3A;

FIG. 3F is a schematic diagram of crystal line endpoints of four crystal lines of a silicon rod on an end face of the silicon rod;

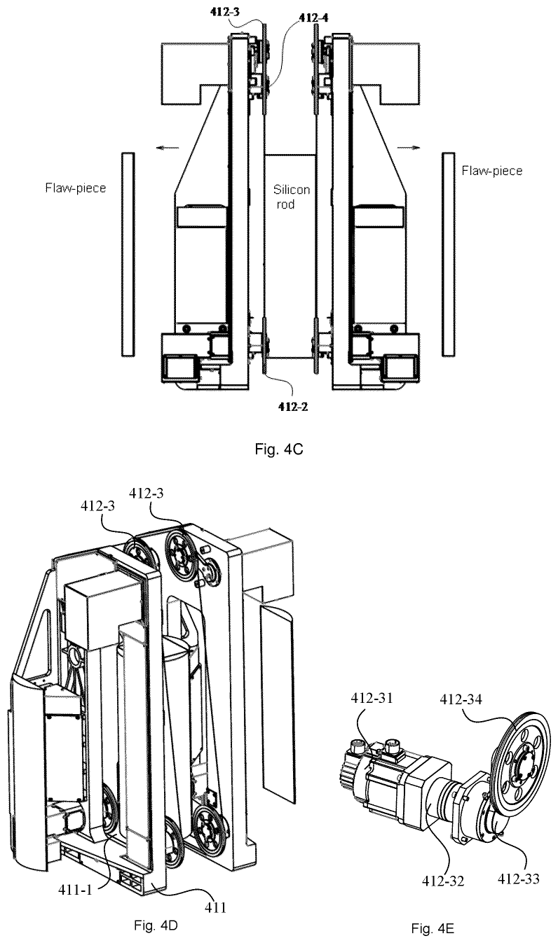

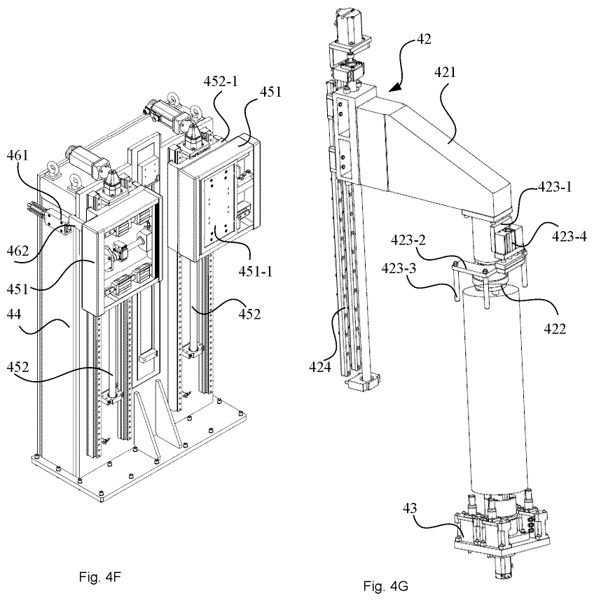

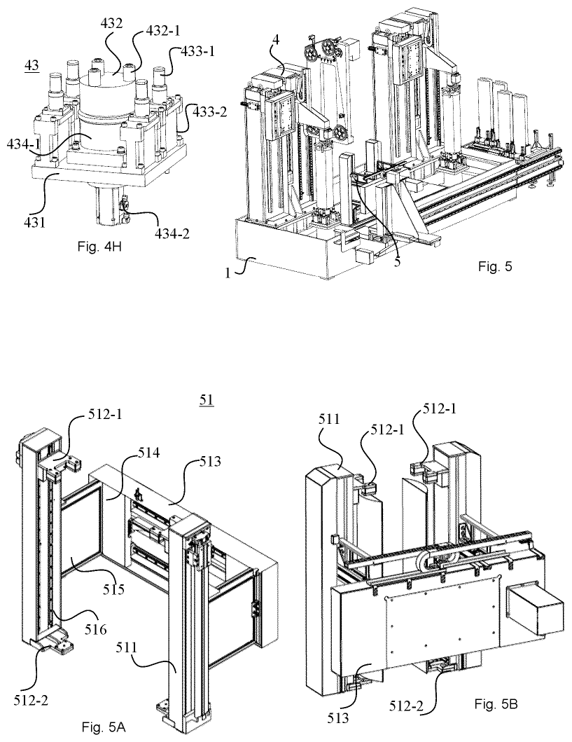

FIG. 4A is a schematic diagram of a cutting machine head mechanism of a cutting device of a silicon rod cutting system according to an embodiment of the present disclosure;

FIG. 4B is a schematic diagram of two cutting machine head mechanisms of the same cutting device of a silicon rod cutting system according to an embodiment of the present disclosure when cutting a silicon rod from top to bottom;

FIG. 4C and FIG. 4D are schematic diagrams of removing, from a machine head through hole, two flaw-pieces formed by one instance of cutting in FIG. 4B;

FIG. 4E is a schematic diagram of a tension wheel assembly of the cutting machine head mechanism shown in FIG. 4A;

FIG. 4F is a schematic diagram of a support frame, a transverse feeding mechanism and a vertical feeding mechanism of the cutting device shown in FIG. 1A;

FIG. 4G is a schematic diagram of a silicon rod chuck mechanism and a silicon rod supporting mechanism of the silicon rod cutting system shown in FIG. 1A cooperating to clamp a silicon rod;

FIG. 4H is a schematic diagram of the silicon rod supporting mechanism shown in FIG. 4G;

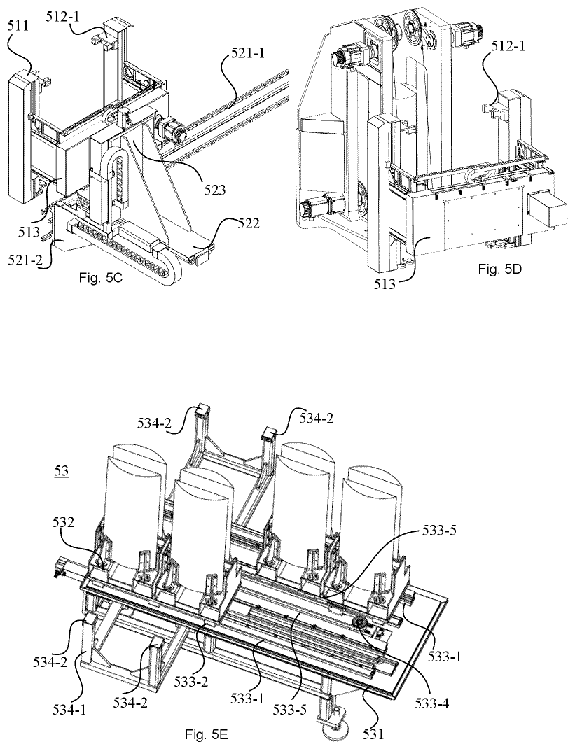

FIG. 5 is a schematic diagram of cooperation among a machine base, two cutting devices and a flaw-piece unloading device of a silicon rod cutting system according to an embodiment of the present disclosure;

FIG. 5A is a schematic diagram of a flaw-piece clamping frame of a flaw-piece unloading device of a silicon rod cutting system according to an embodiment of the present disclosure;

FIG. 5B is a schematic diagram of a relative position of the flaw-piece clamping frame (having a cover plate) shown in FIG. 5A before clamping a flaw-piece;

FIG. 5C is a schematic diagram of the flaw-piece clamping frame shown in FIG. 5A cooperating with a clamping frame movement assembly to form a flaw-piece clamping mechanism;

FIG. 5D is a schematic diagram of mutual cooperation between the flaw-piece clamping frame shown in FIG. 5A and a cutting device of a silicon rod cutting system; and

FIG. 5E is a schematic diagram of a flaw-piece collection mechanism of a flaw-piece unloading device of a silicon rod cutting system according to an embodiment of the present disclosure when collecting flaw-pieces.

### DETAILED DESCRIPTION OF THE EMBODIMENTS

### Optimal Embodiment of the Invention

Exemplary embodiments of the present disclosure are further described in detail below in combination with the drawings.

A silicon rod cutting system in some embodiments of the present disclosure is used for vertically cutting a round silicon rod vertically placed. The process of cutting the silicon rod is shown in FIG. 1, and the round silicon rod is cut twice to form one square rod and four flaw-pieces. The round silicon rod vertically placed is also referred to as a vertical round silicon rod.

As shown in FIG. 1A, FIG. 1B and FIG. 1C, the silicon rod cutting system according to an embodiment of the present disclosure includes:
a machine base 1, provided with two cutting stations that are disposed in parallel and at intervals;
two cutting devices 4, fixed on the machine base 1, wherein the two cutting devices 4 and the two cutting stations are disposed in a one-to-one correspondingly manner; each of the two cutting device 4 is provided with a diamond wire, a part of the diamond wire used for cutting a silicon rod while moving is a cutting segment, the cutting segment is a transversely disposed cutting segment, and the cutting segment is used for cutting, from top to bottom, the silicon rod vertically placed at the cutting stations;
a feeding and blanking device 2, fixed with the machine base 1, wherein the feeding and blanking device 2 is used for feeding a round silicon rod and blanking a square rod formed by cutting; and
a transfer device 3, installed on the machine base 1 and located between the two cutting stations, wherein the transfer device 3 is used for transferring, to the two cutting stations, the silicon rod fed by the feeding and blanking device 2, and is used for transferring, to the feeding and blanking device 2, a square rod formed on the two cutting stations, that is, the transfer device 3 is used for transferring the silicon rod and the square rod between the feeding and blanking device 2 and the cutting device 4.

The height direction of the silicon rod cutting system is a Z direction of the silicon rod cutting system, that is, the Z direction of the silicon rod cutting system is a vertical direction, the arrangement direction of the two cutting stations is an X direction of the silicon rod cutting system, and a Y direction of the silicon rod cutting system is vertical to the X direction and the Z direction of the silicon rod cutting system. Two independent cutting stations are disposed on the machine base in parallel at intervals, the two cutting stations respectively correspond to one cutting device, and the two cutting stations share one feeding and blanking device 2, one transfer device 3 and one flaw-piece unloading device 5. The two cutting stations in the silicon rod cutting system share one feeding and blanking device and one transfer device, so that components of the silicon rod cutting system are fewer, and an occupied space is also smaller.

In some embodiments, as shown in FIG. 1A, FIG. 1B and FIG. 1C, the silicon rod cutting system further includes the flaw-piece unloading device 5, used for clamping, transferring and collecting flaw-pieces formed by cutting the silicon rod.

In some embodiments, the flaw-piece unloading device 5 includes:
a flaw-piece clamping mechanism 51; and
a flaw-piece collection mechanism 53, having collection areas, wherein the collection areas and the cutting stations are in a one-to-one correspondingly manner; and
the flaw-piece clamping mechanism 51 is used for clamping, at the cutting stations, flaw-pieces formed by cutting the silicon rod, and conveying and placing the flaw-pieces in the flaw-piece collection mechanism, and the flaw-pieces formed by cutting the same silicon rod are placed in the same collection area.

The two cutting stations share one flaw-piece clamping mechanism, and the flaw-pieces formed by cutting at the two cutting stations are conveyed and placed in the same flaw-piece collection mechanism. The two cutting stations in the silicon rod cutting system share one flaw-piece clamping mechanism and one flaw-piece collection mechanism, so that the components of the silicon rod cutting system are fewer, and the occupied space is also smaller.

In some embodiments, as shown in FIG. 1A, FIG. 1B, FIG. 1C, FIG. 4A, FIG. 4B, FIG. 4C and FIG. 4D, each cutting device is provided with two cutting machine head mechanisms 41 disposed opposite to each other, each cutting machine head mechanism 41 is provided with a diamond wire and a machine head through hole 411-1 extending in a vertical direction, and the cutting segment of the diamond wire and the machine head through hole 411-1 are disposed in a staggered manner, that is, do not interfere with each other, wherein the cutting segment is a part of the diamond wire for cutting the silicon rod while moving; and
the flaw-piece clamping mechanism is specifically used for entering a space between the two cutting machine head mechanisms 41 from the machine head through hole 411-1 to clamp the flaw-pieces, and exiting from the machine head through hole 411-1 to take out the flaw-pieces from the space between the two cutting machine head mechanisms 41.

Various components of the silicon rod cutting system are described below respectively.

### First Component: The Structure of the Machine Base of the Silicon Rod Cutting System

The machine base of the silicon rod cutting system is a basic supporting member, which has higher rigidity stability. During a workshop layout, the machine base of the silicon rod cutting system and the machine bases of other systems may be connected to form a complete production line.

### Second Component: The Structure of the Feeding and Blanking Device of the Silicon Rod Cutting System

In some embodiments, as shown in FIG. 1A, FIG. 2A, FIG. 2B and FIG. 2C, the feeding and blanking device 2 of the silicon rod cutting system includes a round rod feeding assembly, and the round rod feeding assembly includes:
an round rod feeding rack 211, wherein the round rod feeding rack 211 is L-shaped;
the feeding and blanking device further includes:
a feeding and blanking support frame 23, wherein the round rod feeding rack 211 is rotatably connected with the feeding and blanking support frame 23;
a feeding turnover driving device, respectively fixed with the bottom of the feeding and blanking support frame and an outer bottom of the round rod feeding rack, wherein the feeding turnover driving device is used for driving the round rod feeding rack to turn over by 90 degrees from an initial position of the round rod feeding rack; and
a feeding processing unit, used for controlling the feeding turnover driving device so as to control the round rod feeding rack to first accelerate in turning over, and when the round rod feeding rack turns over by a preset angle, reducing the turnover speed of the round rod feeding rack until the round rod feeding rack turns over by 90 degrees.

In some embodiments, a value range of the preset angle is greater than or equal to 60 degrees and less than or equal to 85 degrees.

In some embodiments, the feeding turnover driving device utilizes a feeding turnover oil cylinder 216;
a cylinder body of the feeding turnover oil cylinder 216 is fixed on the bottom of the feeding and blanking support frame, the upper end of a guide rod of the feeding turnover oil cylinder 216 is fixed with the outer bottom of the round rod feeding rack 211, and the feeding turnover oil cylinder 216 is used for driving the round rod feeding rack 211 to turn over by 90 degrees from the initial position of the round rod feeding rack; and
the feeding processing unit is specifically used for reducing the stretching speed of the feeding turnover oil cylinder 216 when the round rod feeding rack 211 turns over by a preset angle, so as to reduce the turnover speed of the round rod feeding rack 211.

In some embodiments, as shown in FIG. 2A and FIG. 2B, the feeding and blanking device further includes:
a deceleration proximity switch 217, connected with the feeding processing unit and fixed at a position where a long arm of the round rod feeding rack turns over by the preset angle,
wherein the feeding processing unit is specifically used for adjusting, after receiving an in-place signal of the deceleration proximity switch, the flow of an oil inlet of the feeding turnover oil cylinder to reduce the turnover speed until the feeding turnover oil cylinder turns over by 90 degrees.

By means of the cooperation between the deceleration proximity switch and the feeding processing unit, and by means of a simple structure, when the round rod feeding rack turns over by 90 degrees, that is, when the silicon rod is turned over by approximately 90 degrees, the turnover speed is reduced, so that the speed of turning over the silicon rod by 90 degrees is lower, and the impact on the silicon rod is smaller, thereby achieving the effect of protecting the silicon rod.

In some embodiments, as shown in FIG. 2A and FIG. 2B, the inner side of a short arm of the round rod loading rack 211 is a length measurement reference plane 211-1;
the round rod feeding assembly further includes:
a round rod supporting mechanism 212, fixed on the inner side of the long arm of the round rod feeding rack 211, and used for supporting a horizontally placed round silicon rod when the long arm of the round rod feeding rack 211 is transversely placed;
a round rod clamping block 213 and a round rod clamping driving device, wherein the round rod clamping driving device is respectively fixed with the round rod supporting mechanism and the round rod clamping block respectively; and the round rod clamping block 213 is used for pushing, under the driving of the round rod clamping driving device, the round silicon rod located on the round rod supporting mechanism to jack the length measuring datum plane 211-1 for clamping and fixing; and
a clamping block displacement measurement device 215, fixed with the round rod feeding rack 211 and used for measuring the displacement of the round rod clamping block 213; and
the feeding processing unit is further used for obtaining the length of the round silicon rod according to the distance between the initial position of the round rod clamping block and the length measurement reference plane and the displacement of the round rod clamping block, wherein the initial position of the round rod clamping block is a position where the round rod clamping block is located when the round rod clamping driving device extends to the maximum length.

When it is necessary to feed the round silicon rod, firstly, the L-shaped round rod feeding rack is placed such that the long arm of the round rod feeding rack is transversely placed; and then, the round silicon rod is horizontally placed on the round rod supporting mechanism for material presence detection. In order to subsequently transfer and cut the silicon rod, it is necessary to measure the length of the silicon rod. The distance between the position of the length measurement reference plane and the initial position of the round rod clamping block is determined. When the material presence detection indicates material presence, under the driving of a round rod clamping cylinder, the round rod clamping block starts to move from the round rod clamping block until the end face of one side of the silicon rod is pushed to jack a length side beam reference plane, the clamping block displacement measurement device measures the displacement of the round rod clamping block, and then a round rod processing unit calculates the length of the round silicon rod.

In some embodiments, the material presence detection is performed by a photoelectric switch, which is used for material presence detection, of the feeding and blanking device.

In some embodiments, the round rod clamping driving device is a round rod clamping cylinder 214, a cylinder body of the round rod clamping cylinder 214 is fixed with the round rod feeding rack 211, and the round rod clamping block 213 is fixed on the upper end of a guide rod of the round rod clamping cylinder 214,
wherein the round rod clamping block 213 is used for pushing, under the driving of the round rod clamping cylinder 214, the round silicon rod located on the round rod supporting mechanism to jack the length measuring datum plane 211-1 for clamping and fixing; and the initial position of the round rod clamping block is the position where the round rod clamping block is located when the guide rod of the round rod clamping cylinder extends to the maximum length.

In some embodiments, the feeding processing unit is specifically used for obtaining the length L of the round silicon rod according to the following relational expression:

L=K−S;
wherein K denotes the distance between the initial position of the round rod clamping block and the length measurement reference plane, and S denotes the displacement of the round rod clamping block.

In this way, the length of the silicon rod can be quickly and conveniently obtained.

In some embodiments, the clamping block displacement measurement device is a stretching encoder.

The stretching encoder is used as the clamping block displacement measurement device, thereby being small in structure and convenient to install, and by means of cooperation with the feeding processing unit, length measurement of the round silicon rod can be conveniently realized, and the measurement accuracy is also relatively high.

In some embodiments, as shown in FIG. 2A, the feeding and blanking device further includes: two square rod blanking assemblies 22, wherein there are two round rod feeding assemblies, and the two round rod feeding assemblies and the two two square rod blanking assemblies are disposed in parallel.

The feeding processes of the round silicon rod are as follows:
(1) the long arm of the round rod feeding rack is transversely placed on the feeding and blanking support frame, and the silicon rod is fed on the round rod supporting mechanism;
(2) the photoelectric switch fixed at the round rod feeding rack performs detection and sends a material presence signal, then the round rod clamping cylinder ventilates, and the round rod clamping cylinder drives the round rod clamping block to rotate and bounce out while moving; then, the round rod clamping cylinder continues to drive the round rod clamping block to move, so as to push the round rod from one end face of the round rod until the other end face of the round rod jacks the round rod clamping cylinder for clamping and fixing; and
(3) the feeding turnover oil cylinder pushes the outer bottom of the round rod feeding rack, so that the round rod feeding rack rotates around an axis, when turning over to the position of the deceleration proximity switch, the deceleration proximity switch detects in place, and the flow of the oil inlet of the feeding turnover oil cylinder is adjusted by means of the feeding processing unit, so that the turnover speed is reduced until the round rod feeding rack turns over by 90 degrees in place.

The blanking processes of a square rod are as follows:
(1) firstly, the square rod blanking assembly is erected at first, and then a square rod formed by cutting is vertically placed on the square rod blanking assembly; and
(2) the blanking turnover oil cylinder of the square rod unloading assembly retracts back and turns over until to a horizontal position.

### Third Component: The Structure of the Transfer Device of the Silicon Rod Cutting System

As shown in FIG. 1A, FIG. 1B, FIG. 1C, FIG. 3A, FIG. 3B and FIG. 3C, the transfer device 3 of the silicon rod cutting system includes:
a feeding and blanking clamping jaw frame 31;
an upper clamping jaw assembly and a lower clamping jaw assembly, installed on the same side of the feeding and blanking clamping jaw frame 31 in parallel at intervals up and down; and
a transfer driving assembly, used for driving the upper clamping jaw assembly to move up and down relative to the lower clamping jaw assembly in the vertical direction, and is further used for driving the upper clamping jaw assembly and the lower clamping jaw assembly to move up and down synchronously, wherein the up and down movement direction of the upper clamping jaw assembly and the lower clamping jaw assembly is the vertical direction, that is, the Z direction of the silicon rod cutting system.

In some embodiments, the transfer driving assembly includes an upper clamping jaw transfer driving device, respectively fixed with the lower clamping jaw assembly and the upper clamping jaw assembly, and used for driving the upper clamping jaw assembly to move up and down relative to the lower clamping jaw assembly; and
a lower clamping jaw transfer driving device, respectively fixed with the feeding and blanking clamping jaw frame and the lower clamping jaw assembly, and used for driving the lower clamping jaw assembly, the upper clamping jaw assembly and the upper clamping jaw transfer driving device to move up and down synchronously.

By means of the transfer driving assembly, two functions are realized, one function is that the upper clamping jaw assembly may move upwards independently, so that the distance between the upper clamping jaw assembly and the lower clamping jaw assembly can be increased, and the upper clamping jaw assembly may also move downwards independently, so that the distance between the upper clamping jaw assembly and the lower clamping jaw assembly can be reset and reduced. In this way, when the silicon rod or the square rod is relatively short, there may be no need to adjust the distance between the upper clamping jaw assembly and the lower clamping jaw assembly, and only the lower clamping jaw assembly needs to be used for clamping; when the silicon rod or the square rod is relatively long, the distance between the upper clamping jaw assembly and the lower clamping jaw assembly may be kept unchanged, and the upper clamping jaw assembly and the lower clamping jaw assembly are used for clamping at the same time; when the silicon rod or the square rod is extremely long, the distance between the upper clamping jaw assembly and the lower clamping jaw assembly may be increased, so as to stably clamp the silicon rod or the square rod during transfer. The second function is that the transfer device clamps the silicon rod or the square rod, when the silicon rod or the square rod needs to be lifted for rotation, the distance between the upper clamping jaw assembly and the lower clamping jaw assembly remains unchanged, and the upper clamping jaw assembly and the lower clamping jaw assembly move upwards synchronously, that is, the clamped silicon rod or square rod is lifted to transfer the silicon rod or the square rod; and after the silicon rod or the square rod is transferred in place, the distance between the upper clamping jaw assembly and the lower clamping jaw assembly remains unchanged, and the upper clamping jaw assembly and the lower clamping jaw assembly move downwards synchronously, that is, put down the clamped silicon rod or square rod.

In some embodiments, as shown in FIG. 3C, the transfer driving assembly includes:
a transfer gas-liquid cylinder 321, wherein a cylinder body of the transfer gas-liquid cylinder 321 is fixed on the bottom of the feeding and blanking clamping jaw frame 31, and the upper end of a guide rod of the transfer gas-liquid cylinder 321 is fixed with the lower clamping jaw assembly; and
a gas-liquid converter 322, connected with the transfer gas-liquid cylinder 321, wherein a gas entering the gas-liquid converter 322 extrudes hydraulic oil into the transfer gas-liquid cylinder 321, so as to drive the guide rod of the transfer gas-liquid cylinder 321 to jack up the lower clamping jaw assembly; that is, the upper clamping jaw transfer driving device includes the transfer gas-liquid cylinder 321 and the gas-liquid converter 322; and
a transfer cylinder 323, wherein a cylinder body of the transfer cylinder 323 is fixed with the lower clamping jaw assembly, and the upper end of a guide rod of the transfer cylinder 323 is fixed with the upper clamping jaw assembly; and a gas source enters a gas of the transfer cylinder 323, so as to drive the guide rod of the transfer cylinder 323 to jack up the upper clamping jaw assembly; that is, the lower clamping jaw transfer driving device includes the transfer cylinder 323.

By means of the combination manner of the transfer gas-liquid cylinder and the transfer cylinder, the structure of the transfer driving assembly is smaller, so that the overall structure of the transfer device is smaller.

In some embodiments, when a shorter silicon rod is clamped, the transfer cylinder resets and retracts back, and the transfer gas-liquid cylinder extends out; and when a longer silicon rod is clamped, the transfer cylinder and the transfer gas cylinder extend out at the same time.

For example, when the length of the silicon rod is greater than or equal to 150 mm and less than or equal to 400 mm, only the lower clamping jaw assembly clamps the round silicon rod before being cut or the cut square rod, and then the transfer gas-liquid cylinder acts to lift the silicon rod or the square rod for transfer.

When the length of the silicon rod is greater than 400 mm and less than or equal to 850 mm, the distance between the upper clamping jaw assembly and the lower clamping jaw assembly remains unchanged, and the upper clamping jaw assembly and the lower clamping jaw assembly jointly participate in clamping the round silicon rod before being cut or the cut square rod.

When the length of the silicon rod is greater than 850 mm, the upper clamping jaw assembly and the lower clamping jaw assembly jointly participate in clamping the round silicon rod before being cut or the cut square rod, wherein the upper clamping jaw assembly may move up and down in the vertical direction of the feeding and blanking clamping jaw frame due to the action of the transfer cylinder, so as to adapt to clamping round silicon rods before being cut or cut square rods with different lengths.

In some embodiments, as shown in FIG. 3A, FIG. 3D and FIG. 3E, the upper clamping jaw assembly and the lower clamping jaw assembly each includes:
a transfer clamping jaw fixing plate 331;
a left clamping jaw 332-1 and a right clamping jaw 332-2, fixed on the front side of the transfer clamping jaw fixing plate 331 and disposed opposite to each other, wherein the left clamping jaw 332-1 and the right clamping jaw 332-2 may be close to and away from each other, so as to realize clamping and releasing; and the side of the transfer clamping jaw fixing plate on which the left clamping jaw and the right clamping jaw are fixed is the front side of the transfer clamping jaw fixing plate; and
a silicon rod detection assembly, fixed on the front side of the transfer clamping jaw fixing plate 331, wherein a silicon rod detection probe 333 of the silicon rod detection assembly is located between the left clamping jaw 332-1 and the right clamping jaw 332-2;
the transfer device further includes a silicon rod detection processing unit, connected with the silicon rod detection assembly 333, wherein:
the silicon rod detection assembly is used for maintaining a gap between the left clamping jaw 332-1 and the right clamping jaw 332-2 for departing from each other and the silicon rod, that is, not clamping the silicon rod, and when the bottom of the silicon rod is placed on the silicon rod supporting mechanism for rotating, the silicon rod detection probe 333-1 of the silicon rod detection assembly is pressed on the peripheral surface of the silicon rod; and
the silicon rod detection and processing unit is used for obtaining the positions of crystal lines of the silicon rod according to a signal of the silicon rod detection probe of the silicon rod detection assembly, and judging whether the silicon rod meets a preset silicon rod standard.

In some embodiments, the silicon rod detection processing unit is specifically used for:
in the case that the number of the crystal lines of the silicon rod is less than 4 or greater than 4, judging that the silicon rod does not meet the preset silicon rod standard;
in the case that the number of the crystal lines of the silicon rod is 4, as shown in FIG. 3F, among crystal line endpoints 61 of the four crystal lines of the silicon rod 6 on an end face of the silicon rod, connecting lines of every two adjacent crystal line endpoints 61 form four cutting straight lines;
when four included angles α formed by the four cutting straight lines are all greater than or equal to 85 degrees and less than or equal to 95 degrees, determining that the silicon rod meets the preset silicon rod standard and may be subsequently cut; and
if any one of the four included angles formed by the four cutting straight lines is less than 85 degrees or greater than 95 degrees, determining that the silicon rod does not meet the preset silicon rod standard, that is, the crystal lines of the silicon rod are too inclined. A square rod cannot be obtained even if after the silicon rod is cut, so that the silicon rod is not cut subsequently.

In this way, the silicon rod detection assembly cooperates with the silicon rod detection processing unit to judge whether the silicon rod meets the preset silicon rod standard, thereby avoiding cutting the silicon rod that does not meet the preset silicon rod standard, improving the efficiency and reducing time wastes.

The silicon rod detection and processing unit is further used for:
judging the actual eccentricity of the silicon rod placed on the silicon rod supporting mechanism relative to the center of the silicon rod supporting mechanism, and when the actual eccentricity exceeds a preset allowable eccentric range, adjusting the position of the silicon rod; and
judging the actual gradient of the silicon rod placed on the silicon rod supporting mechanism, and when the actual gradient exceeds a preset allowable tilt range, performing manual judgment, wherein the manual judgment includes: when it is confirmed that the actual gradient exceeds the preset allowable tilt range, performing no cutting.

The above processing processes of the silicon rod detection unit need to be performed on the basis of the signal of the silicon rod detection assembly.

In some embodiments, as shown in FIG. 3A, FIG. 3B and FIG. 3C, the transfer device further includes:
two vertical guide rails 341, vertically disposed on one side of the transfer clamping jaw fixing plate 331 in parallel; and
two transfer clamping jaw sliding blocks, fixed on the back side of the transfer clamping jaw fixing plate 331, wherein the transfer clamping jaw sliding blocks are slidably connected with the vertical guide rails 341;
wherein the upper end of the guide rod of the transfer gas-liquid cylinder 321 is fixed with the transfer clamping jaw fixing plate of the lower clamping jaw assembly, and the upper end of the guide rod of the transfer cylinder 323 is fixed with the transfer clamping jaw fixing plate of the upper clamping jaw assembly.

The transfer gas-liquid cylinder is capable of driving the entire lower clamping jaw assembly to move relative to the feeding and blanking clamping jaw frame up and down in the height direction of the feeding and blanking clamping jaw frame. The transfer cylinder is capable of driving the entire upper clamping jaw assembly to move relative to the entire lower clamping jaw assembly up and down in the vertical direction.

In some embodiments, the upper clamping jaw assembly and the lower clamping jaw assembly each further includes:
a synchronous reverse clamping jaw movement assembly, wherein the left clamping jaw and the right clamping jaw are installed with the transfer clamping jaw fixing plate by means of the synchronous reverse clamping jaw movement assembly;
wherein the synchronous reverse clamping jaw movement assembly is used for driving the left clamping jaw and the right clamping jaw to perform synchronous reverse movement, so as to be close to and away from each other.

In this way, the left clamping jaw and the right clamping jaw can conveniently clamp the silicon rod and release the silicon rod at the same time.

In some embodiments, as shown in FIG. 3D and FIG. 3E, the synchronous reverse clamping jaw movement assembly includes:
a transfer clamping jaw cylinder 351, wherein a cylinder body of the transfer clamping jaw cylinder 351 is fixed with the transfer clamping jaw fixing plate 331;
two connecting plates 352, wherein the upper end of a guide rod of the transfer clamping jaw cylinder 351 is fixed with one connecting plate;
two gear racks 353, wherein the gear racks 353 are respectively fixed on opposite sides of the two connecting plates 352; and
a synchronous gear 354, engaged with the two gear racks 353.

In this way, the left clamping jaw and the right clamping jaw can conveniently clamp the silicon rod or the square rod at the same time.

In some embodiments, the transfer device further includes:
a transfer rotating mechanism, wherein the feeding and blanking clamping jaw frame is fixed on the transfer rotating mechanism, and the transfer rotating mechanism is installed on the machine base of the silicon rod cutting system and is located between the two cutting stations of the silicon rod cutting system for moving;
wherein the transfer rotating mechanism is used for driving the feeding and blanking clamping jaw frame to rotate, is further used for moving between two cutting stations of the silicon rod cutting system in a transverse direction of the silicon rod cutting system, and is further used for moving in the Y direction of the silicon rod cutting system, and the Y direction of the silicon rod cutting system is consistent with a front-rear direction of the transfer device for approaching to or departing from the feeding and blanking device of the silicon rod cutting system.

The transfer rotating mechanism is capable of driving the feeding and blanking clamping jaw frame to rotate, is capable of moving between the two cutting stations of the silicon rod cutting system, and is capable of driving the feeding and blanking clamping jaw frame to be close to and away from the feeding and blanking device. In this way, the process of transferring the silicon rod to the cutting stations and the process of transferring the square rod formed by cutting from the cutting stations can be realized. The process of transferring the silicon rod to the cutting stations specifically includes:
turning the upper clamping jaw assembly and the lower clamping jaw assembly towards the feeding and blanking device and be close to the silicon rod vertically carried on the feeding and blanking device, clamping the silicon rod, and lifting up the silicon rod;
retracting back and rotating, so that the silicon rod faces one of the cutting stations; and
at a position close to one of the cutting stations in the X direction of the silicon rod cutting system, putting down the silicon rod, and releasing the silicon rod, so as to complete the transfer of one silicon rod.

The process of transferring the square rod formed by cutting from the cutting stations specifically includes:
turning the upper clamping jaw assembly and the lower clamping jaw assembly towards one of the cutting stations, clamping the square rod formed by cutting, and lifting up the square rod; and
at a position close to the feeding and blanking device in the X direction of the silicon rod cutting system, turning to the square rod blanking assembly of the feeding and blanking device, placing the square rod on the square rod blanking assembly to complete the transfer of one square rod, wherein the square rod blanking assembly completes blanking subsequently.

In some embodiments, as shown in FIG. 3A, the transfer rotating mechanism is mainly composed of a transfer motor, a transfer harmonic speed reducer and a rotary seat 361. A flexible gear of the harmonic speed reducer is installed on the rotary seat 361 at the same time, and a steel wheel of the harmonic speed reducer is installed on the feeding and blanking clamping jaw frame, so that the transfer motor causes, by means of the harmonic speed reducer, the feeding and blanking clamping jaw frame to stably rotate on the rotary seat, and since the transfer harmonic speed reducer may eliminate a reverse gap, the transfer feeding precision of the silicon rod is greatly improved. A rotary drag chain is installed on the rotary seat at the same time for the wiring and piping of a rotary movement. The transfer harmonic speed reducer greatly improves the transfer precision of the silicon rod.

### Fourth Component: The Structure of the Cutting Device of the Silicon Rod Cutting System

### Structure of the Cutting Machine Head Mechanism 41

As shown in FIG. 1A, FIG. 1B and FIG. 1C, regarding the two cutting stations of the silicon rod cutting system, each cutting station corresponds to one cutting device 4, and in one cutting process of one cutting device, two transversely disposed parallel cutting segments of the cutting device cut the silicon rod from top to bottom, so as to form two flaw-pieces.

In order to conveniently take out the flaw-pieces after cutting, the cutting machine head mechanism of the cutting device is structurally improved. As shown in FIG. 4A, FIG. 4B, FIG. 4C and FIG. 4D, the cutting device of the silicon rod cutting system includes the cutting machine head mechanism 41, wherein the cutting machine head mechanism is used for forming transversely disposed cutting segments to cut a vertically placed silicon rod.

The cutting machine head mechanism 41 includes a wire saw assembly; and the wire saw assembly includes:
a wire saw mounting rack 411, provided with a vertical machine head through hole 411-1; and
a diamond wire, disposed on the front side of the wire saw mounting rack 411, wherein the part of the diamond wire used for cutting the silicon rod while moving is a cutting segment; and
the cutting segment and the wire saw mounting rack 411 are disposed in a staggered manner, that is, do not interfere with each other, and the machine head through hole 411-1 is used for enabling a flaw-piece clamping jaw mounting column 511 of a flaw-piece clamping frame 51 of the flaw-piece clamping mechanism to enter and exit.

The structures of the flaw-piece clamping frame 51 and the flaw-piece clamping jaw mounting column 511 are described below in the fifth component. The cutting segment cuts the silicon rod to form a square rod and flaw-pieces, and the flaw-pieces need to be taken out. The process of taking out the flaw-pieces is described in combination with FIG. 5A, FIG. 5B, FIG. 5C and FIG. 5D:

the flaw-piece clamping jaw mounting column 511 of the flaw-piece clamping frame 51 of the flaw-piece clamping mechanism passes through the machine head through hole forwards, and the flaw-piece clamping mechanism clamps the flaw-pieces; and then, the flaw-piece clamping mechanism passes through the machine head through hole 411-1 backwards carrying the flaw-pieces, so as to remove the flaw-pieces from the cutting stations. In this process, the wire saw mounting rack itself does not need to move. Since the wire saw mounting rack of the wire saw assembly of the cutting machine head mechanism of the cutting device is provided with the machine head through hole, there is no need to move the wire saw mounting rack during the process of removing the flaw-pieces from the cutting stations, thereby saving on the time, and improving the efficiency of taking out the flaw-pieces, such that the procedures of removing the flaw-pieces from the cutting stations is simpler, and thus the efficiency of the silicon rod cutting system is higher.

In some embodiments, the machine head through hole 411-1 is a vertically formed elongated machine head through hole.

In some embodiments, the wire saw mounting rack is a rigid wire saw mounting rack.

In some embodiments, as shown in FIG. 4A, FIG. 4B, FIG. 4C and FIG. 4D, the cutting segment is a transversely disposed cutting segment and is lower than the machine head through hole 411-1.

The cutting machine head mechanism is capable of moving from top to bottom to cut the silicon rod. During the process of the cutting machine head mechanism moving from top to bottom, the transversely disposed cutting segments cuts the vertically disposed silicon rods from top to bottom. After the cutting is completed, the cutting segment is lower than the lower end face of the silicon rod. At this time, the flaw-pieces are removed from the cutting station via the machine head through hole, and since the cutting segment is lower than the machine head through hole, the cutting segment does not interfere with the moving flaw-pieces.

In some embodiments, as shown in FIG. 4A, the wire saw assembly further includes:
a driving wheel assembly 412-1 and a lower transition wheel 412-2, respectively disposed on the front side of the wire saw mounting rack 411;
a tension wheel assembly 412-3 and an upper transition wheel 412-4, respectively disposed on the front side of the wire saw mounting rack 411; and
an annular diamond wire, twined on the peripheral surfaces of a driving wheel of the driving wheel assembly 412-1, the lower transition wheel 412-2, a tension wheel of the tension wheel assembly 412-3 and the upper transition wheel 412-4, wherein the cutting segments are formed on bottom ends of the driving wheel and the lower transition wheel, and the diamond wire and the machine head through hole do not interfere with each other.

The driving wheel assembly is disposed at the lower part of the front side of the wire saw mounting rack. The tension wheel assembly applies tension to the annular diamond wire, so that the annular diamond wire maintains certain tension to effectively cut the silicon rod. The orientation of the annular diamond wire is adjusted by the lower transition wheel and the upper transition wheel.

In some embodiments, as shown in FIG. 4B, FIG. 4C and FIG. 4D, one cutting station of the silicon rod cutting system corresponds to one cutting device, one cutting device includes two cutting machine head mechanisms 41, and the cutting segments of the two cutting machine head mechanisms 41 are disposed opposite to each other.

One cutting device is provided with two cutting machine head mechanisms, and the cutting segments of the two cutting machine head mechanisms are disposed opposite to each other, in this way, one cutting device is capable of cutting the two opposite sides of the silicon rod that is vertically disposed at the cutting station, so as to form two flaw-pieces opposite to each other, therefore the cutting efficiency of the silicon rod is higher.

In some embodiments, the two cutting machine head mechanisms of one cutting device are disposed opposite to each other, that is, the two cutting machine head mechanisms include a present-side cutting machine head mechanism and an opposite-side cutting machine head mechanism. Each cutting machine head mechanisms further includes:
a cleaning assembly, fixed on the front side of the wire saw mounting rack,
wherein the cleaning assembly is provided with a plurality of cleaning nozzles, a first part of cleaning nozzles is used for cleaning the opposite-side cutting machine head mechanism and the present-side cutting machine head mechanism, and a second part of cleaning nozzles is used for cleaning the opposite-side cutting machine head mechanism.

The present-side cutting machine head mechanism may also be cleaned by the first part of cleaning nozzles of the present-side cutting machine head mechanism, the first part of cleaning nozzles of the opposite-side cutting machine head mechanism and the second part of cleaning nozzles of the opposite-side cutting machine head mechanism, so that the present-side cutting machine head mechanism is also cleaned by the cleaning nozzles in a plurality of directions. In this way, each cutting machine head mechanism is cleaned by the cleaning nozzles in the plurality of directions, and thus the cleaning efficiency is high. The cleaning assembly mainly cleans the opposite-side cutting machine head mechanism, and also cleans the present-side cutting machine head mechanism at the same time.

In some embodiments, as shown in FIG. 4A, the cleaning assembly includes:
a first lower cleaning assembly 413-1, fixed on the front side of the wire saw mounting rack 411 and located above the driving wheel assembly 412-1, wherein the first part of cleaning nozzles of the first lower cleaning assembly is used for cleaning the driving wheels of the driving wheel assemblies 412-1 of the opposite-side cutting machine head mechanism and the present-side cutting machine head mechanism, and the second part of cleaning nozzles is used for cleaning the driving wheel of the driving wheel assembly of the opposite-side cutting machine head mechanism; and
a second lower cleaning assembly 413-2, fixed on the front side of the wire saw mounting rack 411 and located above the lower transition wheel 412-2, wherein the first part of cleaning nozzles of the second lower cleaning assembly is used for cleaning the lower transition wheels 412-2 of the opposite-side cutting machine head mechanism and the present-side cutting machine head mechanism, and the second part of cleaning nozzles is used for cleaning the lower transition wheel of the opposite-side cutting machine head mechanism.

By means of adjusting the orientations of the first part of cleaning nozzles and the second part of cleaning nozzles of the first lower cleaning assembly, respective cleaning functions are implemented. By means of adjusting the orientations of the first part of cleaning nozzles and the second part of cleaning nozzles of the second lower cleaning assembly, respective cleaning functions are implemented.

In some embodiments, as shown in FIG. 4A, the cleaning assembly further includes:
a first upper cleaning assembly 413-3, fixed on the front side of the wire saw mounting rack 411 and located above the tension wheel assembly 412-3, wherein the first part of cleaning nozzles of the first upper cleaning assembly is used for cleaning the tension wheels of the tension wheel assemblies 412-3 of the opposite-side cutting machine head mechanism and the present-side cutting machine head mechanism, and the second part of cleaning nozzles is used for cleaning the tension wheel of the tension wheel assembly of the opposite-side cutting machine head mechanism; and
a second upper cleaning assembly 413-4, fixed on the front side of the wire saw mounting rack and located above the upper transition wheel 412-4, wherein the first part of cleaning nozzles of the second upper cleaning assembly is used for cleaning the upper tension wheels 412-4 of the opposite-side cutting machine head mechanism and the present-side cutting machine head mechanism, and the second part of cleaning nozzles is used for cleaning the upper tension wheel of the opposite-side cutting machine head mechanism.

By means of adjusting the orientations of the first part of cleaning nozzles and the second part of cleaning nozzles of the first upper cleaning assembly, respective cleaning functions are implemented. By means of adjusting the orientations of the first part of cleaning nozzles and the second part of cleaning nozzles of the second upper cleaning assembly, respective cleaning functions are implemented.

In some embodiments, when the silicon rod is vertically placed at the cutting station, the positions of the first lower cleaning assembly and the second lower cleaning assembly are located outside the silicon rod, that is, the first lower cleaning assembly and the second lower cleaning assembly are respectively staggered to the silicon rod, that is, do not interfere with each other.

In this way, the first lower cleaning assembly and the second lower cleaning assembly can clean the opposite-side cutting machine head mechanism without being blocked by the silicon rod.

In some embodiments, as shown in FIG. 4B, FIG. 4C and FIG. 4D, the first upper cleaning assembly 413-3 and the second upper cleaning assembly 413-4 are higher than the cut silicon rod.

In this way, the silicon rod can be cleaned from the upper side of the cut silicon rod, and the cut silicon rod can be cleaned from top to bottom by means of the downward flowing process of cleaning liquid.

In some embodiments, the cutting machine head mechanism further includes:
a spray assembly, wherein the spray assembly is fixed on the front side of the wire saw mounting rack, and the spray assembly performs spray for a preset front spray time before every instance of cutting and in a spray process; and
the spray assembly is provided with a spray head, and the spray head is used for spraying cutting fluid to the silicon rod and a cutting seam formed by cutting the silicon rod via the annular diamond wire, and performing cooling.

The spray head of the spray assembly sprays the cutting fluid to the silicon rod and the cutting seam formed by cutting the silicon rod via the annular diamond wire, thereby facilitating the cutting of the silicon rod on one hand, and cooling the annular diamond wire on the other hand, thus avoiding the temperature being too high.

In some embodiments, as shown in FIG. 4A, the spray assembly includes:
a lower spray assembly 414-1, fixed on the front side of the wire saw mounting rack 411, wherein the lower spray assembly 414-1 is provided with a plurality of lower spray heads disposed at intervals up and down, and the plurality of lower spray heads of the lower spray assembly 414-1 are used for spraying a cutting seam formed by cutting the silicon rod via the cutting segment;
an upper spray assembly 414-2, fixed on the front side of the wire saw mounting rack 411 and located between the tension wheel assembly 412-3 and the machine head through hole 411-1, wherein the upper spray assembly 414-2 is provided with a plurality of upper spray heads disposed transversely at intervals, and the plurality of upper spray heads of the upper spray assembly are used for spraying the upper end face of the silicon rod.

When being located above the silicon rod, the plurality of lower spray heads of the lower spray assembly spray the cutting fluid to the cutting seam formed by cutting the silicon rod via the cutting segment; and when starting to cut the silicon rod, the plurality of lower spray heads of the lower spray assembly spray the cutting fluid to the annular diamond wire and especially the cutting segment. The plurality of upper spray heads of the upper spray assembly spray the cutting fluid to the upper end face of the silicon rod, so that the cutting is faster, and meanwhile, as the cutting segment cuts the silicon rod from top to bottom, the cutting fluid also flows downwards along the cutting segment, thereby also cooling the annular diamond wire and especially the cutting segment.

In some embodiments, as shown in FIG. 4E, the tension wheel assembly 412-3 is composed of a tension motor 412-31, a speed reducer 412-32, a tension swing rod 412-33, and a tension wheel 412-34. Due to the functions of the speed reducer, it can be ensured that a small motor outputs a large torque, thereby saving the motor cost. Stop blocks are disposed on the two sides of the tension swing rod, so that the tension swing rod rotates within a certain angle.

### Structures of a Support Frame 44, a Transverse Feeding Mechanism and a Vertical Feeding Mechanism

In some embodiments, as shown in FIG. 4F, the cutting device 4 further includes:
a support frame 44, installed on the machine base 1 of the silicon rod cutting system; and
transverse feeding mechanisms 451 in one-to-one correspondence with the cutting machine head mechanisms 41, wherein the cutting machine head mechanisms are fixed with the transverse feeding mechanisms corresponding thereto, the two cutting segments are disposed opposite to each other, and the transverse feeding mechanisms 451 are slidably connected with the support frame, so as to drive the two cutting segments to be close to and away from each other; and the transverse feeding mechanisms 451 are used for driving the two cutting machine head mechanisms 41 to move close to and away from each other, and adjusting the distance between the cutting segments of the two cutting machine head mechanisms of the same cutting device.

In this way, under the driving of the two transverse feeding mechanisms, the two cutting machine head mechanisms of the same cutting device can be close to and away from each other, so that the distance between the cutting segments of the two cutting machine head mechanisms of the same cutting device can be adjusted. That is, the two cutting segments of the same cutting machine head mechanism are disposed in parallel, and the distance between the two cutting segments is adjustable. The brought beneficial effect are that the cutting device may be applicable to cutting silicon rods of various diameters, so that the universality of the cutting device is very high.

The transverse feeding mechanisms and the vertical feeding mechanisms form a feeding mechanism.

In some embodiments, as shown in FIG. 4F, the cutting device further includes:
vertical feeding mechanisms 452, in one-to-one correspondence with the transverse feeding mechanisms and vertically fixed on the same side of the support frame 44 respectively, wherein the vertical feeding mechanisms 452 are fixed with the transverse feeding mechanisms 451 corresponding thereto, so as to drive the cutting machine head mechanisms to move in the vertical direction; and
the two vertical feeding mechanisms 452 are used for driving the two transverse feeding mechanisms to move in the vertical direction, so as to drive the cutting machine head mechanism to move in the vertical direction.

In this way, the vertical feeding mechanisms can drive the transverse feeding mechanisms corresponding thereto to move in the vertical direction, that is, the Z direction, so as to drive the cutting machine head mechanisms and the cutting segments thereof to move in the vertical direction, that is, the Z direction. Therefore, the vertically placed silicon rod is cut from top to bottom in the Z direction, and the cutting machine head mechanisms and the cutting segments thereof are driven to reset after each instance of cutting is completed.

In an implementation, as shown in FIG. 4F, the transverse feeding mechanism includes:
a transverse wire saw guide rail lead screw, wherein a nut of the transverse wire saw guide rail lead screw is fixed at the vertical feeding mechanism; and the guide direction of a guide rail of the transverse wire saw guide rail lead screw is a direction in which the two cutting segments are close to and away from each other;
a transverse wire saw sliding plate 451-1, fixed with a sliding block of the transverse wire saw guide rail lead screw and fixed with the cutting machine head mechanism; and
a transverse wire saw driving motor and a transverse wire saw speed reducer, wherein the transverse wire saw driving motor and the transverse wire saw speed reducer are connected to output a rotational movement to the transverse wire saw guide rail lead screw; and
the transverse wire saw guide rail lead screw is used for converting the received rotational movement into a linear movement along the guide rail of the transverse wire saw guide rail lead screw, and driving, by means of the sliding block of the transverse wire saw guide rail lead screw and the transverse wire saw sliding plate, the cutting machine head mechanism to move in the transverse direction, that is, the X direction.

The transverse wire saw guide rail lead screw and the transverse wire saw sliding plate implement the transverse feeding mechanism by means of a simple structure.

In some embodiments, as shown in FIG. 4F, the vertical feeding mechanism includes:
a vertical wire saw guide rail lead screw, wherein a nut of the vertical wire saw guide rail lead screw is fixed at the support frame; and the guide direction of a guide rail of the vertical wire saw guide rail lead screw is an upper-lower vertical direction, that is, the Z direction;
a vertical wire saw sliding plate 452-1, fixed with a sliding block of the vertical wire saw guide rail lead screw and fixed with the nut of the transverse wire saw guide rail lead screw; and
a vertical wire saw driving motor and a vertical wire saw speed reducer, wherein the vertical wire saw driving motor and the vertical wire saw speed reducer are used for outputting a rotary movement to the vertical wire saw guide rail lead screw; and
the vertical wire saw guide rail lead screw is used for converting the received rotational movement into a linear movement along the guide rail of the vertical wire saw guide rail lead screw, and driving, by means of the sliding block of the vertical wire saw guide rail lead screw, the transverse feeding mechanism and the cutting machine head mechanism to move in the vertical direction.

The nut of the vertical wire saw guide rail lead screw and the support frame are fixed into a whole, and are fixed relative to the machine base. The sliding block of the vertical wire saw guide rail lead screw and the nut of the transverse wire saw guide rail lead screw are fixed into a whole. The sliding block of the vertical wire saw guide rail lead screw, the vertical wire saw sliding plate and the nut of the transverse wire saw guide rail lead screw may move in the vertical direction as a whole, so as to drive the transverse feeding mechanism to move in the vertical direction, thereby driving the cutting machine head mechanism and the cutting segment thereof to move in the vertical direction.

In some embodiments, the cutting device further includes:
a feeding control unit, respectively connected with two transverse wire saw driving motors and two vertical wire saw driving motors of the same cutting device, used for controlling the distance between the cutting segments of the two cutting machine head mechanisms, and also used for controlling the movement of the two cutting machine head mechanisms in the vertical direction.

By means of the cooperation among the feeding control unit, the transverse wire saw driving motors and the vertical wire saw driving motors, the distance between the cutting segments of the two cutting machine head mechanisms in the transverse direction may be conveniently controlled, and the movement of the cutting segments of the two cutting machine head mechanisms in the vertical direction is controlled for cutting, that is, the cutting may also be controlled.

In some embodiments, as shown in FIG. 4F, the vertical feeding mechanism further includes:
a blocking latch 461, wherein a socket of the blocking latch 461 is fixed on the upper part of a side face of the support frame 44; and
a blocking strip 462, transversely fixed at the vertical wire saw sliding plate 452-1,
wherein the blocking latch is used for: when the cutting machine head mechanism moves to the highest position, a plug of the blocking latch may extend out to block the blocking strip from moving downwards, so as to prevent the vertical wire saw sliding plate and the cutting machine head mechanism from moving downwards.

By means of the cooperation between the blocking latch and the blocking strip, the downward movement of the vertical wire saw sliding plate is implemented by mechanical structures. When the cutting machine head mechanism moves to the highest position, there is a need for a person to enter a space below the cutting machine head mechanism to maintain the device, the cutting machine head mechanism may accidentally fall, causing personnel injury. By means of the cooperation between the blocking latch and the blocking strip, the cutting machine head mechanism is prevented from accidentally falling via mechanical blocking.

### Structure of a Silicon Rod Chuck Mechanism 42

In some embodiments, as shown in FIG. 4G, the cutting device includes a silicon rod chuck mechanism 42, and the silicon rod chuck mechanism 42 includes:
a chuck rack 421;
an upper floating head 422, installed at the chuck rack 421 and used for pressing an upper end face of the vertically placed silicon rod; and
a flaw-piece holding rack, connected with the chuck rack 421 and capable of extending out downwards and resetting upwards, wherein the flaw-piece holding rack is used for extending out downwards and holding the peripheral surface of the silicon rod, and the flaw-piece holding rack is further used for resetting upwards to leave the peripheral surface of the silicon rod.

The chuck rack is an installation base. The upper floating head is used for pressing the upper surface of the vertically placed silicon rod to clamp the silicon rod in the vertical direction. During the process of cutting the silicon rod, the upper floating head itself may tilt for a preset angle to reduce or cancel the stress generated by cutting. In order to prevent flaw-pieces formed by the cut silicon rod from toppling over, the flaw-piece holding rack is provided. The flaw-piece holding rack is connected with the chuck rack and is capable of extending out downwards and resetting upwards. In this way, after the cutting segments are placed on the upper end face of the silicon rod, the flaw-piece holding rack extends out downwards and holds the peripheral surface of the silicon rod, so that the silicon rod is cut at the cutting segments to form a square rod and flaw-pieces, and the flaw-piece holding rack holds the flaw-pieces on the outer side of the upper end, thereby avoiding the possibility that the flaw-pieces are likely to topple over. When the flaw-pieces need to be taken away, the flaw-piece holding rack is reset upwards and is no longer in contact with the flaw-pieces, so that the flaw-pieces can be taken away.

In some embodiments, the chuck rack is a rigid chuck rack.

In some embodiments, the chuck rack is capable of moving up and down, and the upper floating head is used for pressing the upper end face of the vertically placed silicon rod.

In some embodiments, the upper floating head is installed on a downward end face of the chuck rack.

In this way, the upper floating head can be conveniently pressed on the upper end face of the vertically placed silicon rod, and can also conveniently leave the upper end face of the cut silicon rod.

In some embodiments, as shown in FIG. 4G, the flaw-piece holding rack includes:
a flaw-piece holding rack mounting member 423-1, fixed with the chuck rack;
a holding rod fixing member 423-2 and a flaw-piece holding rod 423-3, wherein the flaw-piece holding rod 423-3 is fixed on the side of the holding rod fixing member 423-2 that is away from the upper floating head and extends out downwards; and
a flaw-piece holding driving device, connected with the flaw-piece holding rack mounting member and the holding rod fixing member respectively, and used for driving the holding rod fixing member and the flaw-piece holding rod to extend out downwards and reset upwards.

In some embodiments, as shown in FIG. 4G, the flaw-piece holding driving device is a flaw-piece holding driving cylinder 423-4, a cylinder body of the flaw-piece holding driving cylinder is fixed with the flaw-piece holding rack mounting member 423-1, a guide rod of the flaw-piece holding driving cylinder is fixed with the holding rod fixing member 423-2, and the guide rod of the flaw-piece holding driving cylinder extends out and retracts back, so as to drive the holding rod fixing member 423-2 and the flaw-piece holding rod 423-3 to extend out downwards and reset upwards.

The holding rod fixing member is fixed into a whole with the flaw-piece holding rod, and is connected with the flaw-piece holding rack mounting member via the flaw-piece holding driving cylinder. If the guide rod of the flaw-piece holding driving cylinder extends out, the holding rod fixing member and the flaw-piece holding rod extend out as a whole, and the flaw-piece holding rod holds the peripheral surface of the silicon rod. If the guide rod of the flaw-piece holding driving cylinder retracts back, the holding rod fixing member and the flaw-piece holding rod retract back as a whole, so as to drive the flaw-piece holding rod to retract back upwards to leave the silicon rod.

In some embodiments, as shown in FIG. 4G, four flaw-piece holding rods 423-3 are fixed around one holding rod fixing member 423-2.

In this way, the two flaw-pieces are held on the peripheral surface of the silicon rod by the four flaw-piece holding rods of one holding rod fixing member, and each flaw-piece is held by two flaw-piece holding rods.

After the cutting segment is placed on the upper end face of the vertically-placed silicon rod, the flaw-piece holding rod extends out downwards to hold the peripheral surface of the silicon rod. After a single instance of cutting is completed, the flaw-piece holding rod retracts back upwards to remove the two flaw-pieces.

In some embodiments, as shown in FIG. 4G, the silicon rod chuck mechanism further includes:
a vertical chuck rack movement assembly 424, fixed with the support frame 44 and located between the two cutting machine head mechanisms 41,
wherein the chuck rack is connected with the vertical chuck rack movement assembly, and the vertical chuck rack movement assembly is used for driving the chuck rack to move up and down in the vertical direction, that is, the Z direction, so as to drive the upper floating head to press the upper end face of the vertically placed silicon rod and leave the upper end face of the cut silicon rod.

### Structure of a Silicon Rod Supporting Mechanism 43

In some embodiments, as shown in FIG. 4H, the cutting device further includes a silicon rod supporting mechanism 43, used for supporting the lower end face of the vertically placed silicon rod, wherein the silicon rod supporting mechanism 43 is fixed at the cutting station. The silicon rod supporting mechanism includes:
a silicon rod supporting mounting base 431, wherein the silicon rod supporting mounting base 431 is fixed at the machine base of the silicon rod cutting system, that is, the silicon rod supporting mounting base is fixed at a position corresponding to one cutting station on the machine base; and
a lower floating head 432, used for supporting the lower end face of the vertical silicon rod, wherein the lower floating head is installed above the silicon rod supporting mounting base 431.

In this way, during the process of cutting the silicon rod, the lower floating head itself may tilt for a preset angle to reduce or cancel the stress generated by cutting. When the cutting segment of the cutting machine head mechanism performs cutting from top to bottom, the stress generated by the cutting may be reduced or canceled by the tilt of the lower floating head, thereby preventing edge breakage when the lower part of the silicon rod is cut.

In some embodiments, as shown in FIG. 4H, the silicon rod supporting mechanism further includes a flaw-piece supporting assembly, and the flaw-piece supporting assembly includes:
a flaw-piece supporting driving device, fixed on the silicon rod supporting mounting base 431 and spaced apart from the lower floating head;
a flaw-piece supporting head 433-1, used for supporting a position where the lower end face of the silicon rod is cut to form flaw-pieces, wherein the flaw-piece supporting head 433-1 is fixed on a top end of the flaw-piece supporting driving device; and the flaw-piece supporting driving device is used for locking when the silicon rod is cut into a square rod and flaw-pieces, so that the flaw-piece supporting head keeps the height to support the flaw-pieces.

The process of placing the silicon rod on the silicon rod supporting mechanism is as follows:
first, the flaw-piece supporting head is located at an initial position, and the top end of the flaw-piece supporting head at the initial position is lower than the top end of a lower floating head supporting head;
then, the silicon rod is placed on the lower floating head, and the lower floating head supporting head supports the lower end face of the silicon rod; and
next, the flaw-piece supporting head is jacked upwards, and the flaw-piece supporting driving device locks the height of the flaw-piece supporting head.

When the cutting segment of the cutting machine head mechanism 41 performs cutting from top to bottom, the stress generated by cutting drives the lower floating head to tilt slightly, and the flaw-piece supporting head always supports the flaw-pieces. In this way, the lower floating head cooperates with the flaw-piece supporting head to reduce or cancel the stress generated by cutting, so as to prevent edge breakage when the lower part of the silicon rod is cut.

In some embodiments, the flaw-piece supporting driving device is a flaw-piece supporting cylinder 433-2; and
a cylinder body of the flaw-piece supporting cylinder 433-2 is fixed with the silicon rod support mounting base 431, and a guide rod of the flaw-piece supporting cylinder 433-2 is fixed with the flaw-piece supporting head 433-1.

In some embodiments, as shown in FIG. 4H, the lower floating head is provided with three lower floating head supporting heads 432-1 protruding upwards, and the three lower floating head supporting heads 432-1 are located at three vertices of one triangle. The three lower floating head supporting heads may determine one plane, so that each of the three lower floating head supporting heads supports the lower end face of the silicon rod.

In some embodiments, the upper floating head is provided with three upper floating head pressing heads protruding downwards, and the three upper floating head pressing heads are located at three vertices of one triangle. The three upper floating head pressing heads may determine one plane, so that each of the three upper floating head pressing heads presses the lower end face of the silicon rod.

When the cutting segment of the cutting machine head mechanism performs cutting from top to bottom, the lower floating head slightly tilts under the driving of the stress generated by cutting, but the upper floating head may compensate for the tilt, so that the silicon rod can be stably clamped between the lower floating head and the upper floating head.

In some embodiments, four flaw-piece supporting assemblies are provided, and the four flaw-piece supporting assemblies are located at four vertexes of one rectangle; and two flaw-piece supporting assemblies are used for supporting one flaw-piece formed by cutting one silicon rod.

A pair of flaw-piece supporting assemblies may effectively support one flaw-piece.

In some embodiments, as shown in FIG. 4H, the silicon rod supporting mechanism further includes a silicon rod rotating assembly, and the silicon rod rotating assembly includes:
a silicon rod rotating shaft 434-1, wherein the lower floating head is fixed on the silicon rod rotating shaft 434-1, and the silicon rod rotating shaft 434-1 is rotationally connected above the silicon rod supporting mounting base 431; and
a silicon rod driving motor 434-2, fixed below the silicon rod supporting mounting base 431, and connected with the silicon rod rotating shaft 434-1 so as to drive the silicon rod rotating shaft 434-1 to rotate.

During first-time cutting of the silicon rod, after two flaw-pieces are formed and the two flaw-pieces are removed, the flaw-piece supporting head is moved downwards to reset. The silicon rod driving motor drives the silicon rod rotating shaft to rotate by 90 degrees, so as to drive the lower floating head and the silicon rod sandwiched between the lower floating head and the upper floating head to rotate by 90 degrees. In order to rotate the silicon rod by 90 degrees, the silicon rod driving motor is capable of driving the silicon rod rotating shaft to rotate by 90 degrees, and the silicon rod passively rotates by 90 degrees to prepare for subsequent second-time cutting.

### Fifth Component: The Structure of the Flaw-Piece Unloading Device 5 of the Silicon Rod Cutting System

As shown in FIG. 1A and FIG. 5, two cutting devices 4 are fixed on the machine base 1, each cutting device 4 is used for cutting the silicon rod from top to bottom, so as to form a square rod and flaw-pieces, and the flaw-piece unloading device 5 unloads the flaw-pieces.

In some embodiments, as shown in FIG. 1A, FIG. 5, FIG. 5A, FIG. 5B, FIG. 5C and FIG. 5D, the flaw-piece unloading device 5 of the silicon rod cutting system includes:
a flaw-piece clamping mechanism; and
a flaw-piece collection mechanism 53,
wherein the flaw-piece clamping mechanism is used for clamping flaw-pieces formed by cutting a silicon rod into a square rod, and conveying the flaw-pieces to the flaw-piece collection mechanism 53 for storage.

In some embodiments, the flaw-piece collection mechanism 53 has collection areas, and the collection areas are in one-to-one correspondence with the cutting stations of the silicon rod cutting system; and
the flaw-piece unloading device further includes a collection control unit, and the collection control unit is used for controlling the flaw-piece clamping mechanism to clamp the flaw-pieces generated by the cut silicon rod from each cutting station and to convey and place the flaw-pieces in the flaw-piece collection mechanism, and the flaw-pieces generated by cutting the same silicon rod are placed in the same collection area.

In the flaw-piece unloading device of the silicon rod cutting system according to the embodiment of the present disclosure, the flaw-piece collection mechanism is divided into the collection areas, and the collection areas are in one-to-one correspondence with the cutting stations of the silicon rod cutting system. By means of the collection control unit, the flaw-piece clamping mechanism is controlled to clamp the flaw-pieces generated by the cut silicon rod from each cutting station and to convey and place the flaw-pieces in the collection areas in the flaw-piece collection mechanism, and the flaw-pieces generated by cutting the same silicon rod are placed in the same collection area, that is, the four flaw-pieces generated by cutting the same silicon rod into the square rod are collected in the same collection area of the flaw-piece collection mechanism, so that a basis is provided for subsequently pasting identifiers on the four flaw-pieces generated by the same silicon rod and for performing subsequent management.

In some embodiments, the silicon rod is encoded to form a silicon rod code, so as to distinguish each silicon rod. The silicon rod is cut to form one square rod and four flaw-pieces, and the four flaw-pieces from the same silicon rod are collected in the same collection area of the flaw-piece collection mechanism. In this way, the flaw-pieces placed in the same collection area are all from the same silicon rod, thereby facilitating subsequent encoding of the flaw-pieces, and the codes of the flaw-pieces comprise a silicon rod code and a digital code, for example, a silicon rod code-1, a silicon rod code-2, a silicon rod code-3 and a silicon rod code-4.

### Structure of the Flaw-Piece Clamping Mechanism 51

In some embodiments, as shown in FIG. 5A, FIG. 5B, FIG. 5C and FIG. 5D, the flaw-piece clamping mechanism includes a flaw-piece clamping frame 51, and the flaw-piece clamping frame 51 includes:
a flaw-piece clamping jaw mounting column 511; and
a top clamping jaw 512-1 and a bottom clamping jaw 512-2, installed on the front side of the flaw-piece clamping jaw mounting column 511 and disposed up and down opposite to each other,
wherein at least one of the top clamping jaw 512-1 and the bottom clamping jaw 512-2 is slidably connected with the flaw-piece clamping jaw mounting column and is capable of moving up and down in the vertical direction, that is, the Z direction of the silicon rod cutting system, and the side of the flaw-piece clamping jaw mounting column on which the top clamping jaw 512-1 and the bottom clamping jaw 512-2 are installed is the front side.

The flaw-piece clamping frame and the flaw-piece clamping jaw mounting column of the flaw-piece clamping mechanism are installation bases of the top clamping jaw and the bottom clamping jaw. At least one of the top clamping jaw 512-1 and the bottom clamping jaw 512-2 is slidably connected with the flaw-piece clamping jaw mounting column, so that the distance between the top clamping jaw 512-1 and the bottom clamping jaw 512-2 can be adjusted. When a vertical flaw-piece needs to be clamped, the distance between the top clamping jaw and the bottom clamping jaw is adjusted to be greater than the vertical flaw-piece to be clamped at first; then, the top clamping jaw and the bottom clamping jaw are located on the two ends of the vertical flaw-piece; and next, the distance between the top clamping jaw and the bottom clamping jaw is adjusted in the Z direction of the silicon rod cutting system, so that the top clamping jaw and the bottom clamping jaw clamp two end faces of the flaw-piece, thus clamping the vertical flaw-piece in the vertical direction.

In some embodiments, the flaw-piece clamping jaw mounting column is a rigid flaw-piece clamping jaw mounting column.

In some embodiments, as shown in FIG. 5A, FIG. 5B, FIG. 5C and FIG. 5D, the bottom clamping jaw 512-2 is fixed on a bottom end of the flaw-piece clamping jaw mounting column 511; and
the top clamping jaw 512-1 is slidably connected with the flaw-piece clamping jaw mounting column 511, and the top clamping jaw 512-1 is capable of moving up and down in the vertical direction, that is, the Z direction of the silicon rod cutting system.

The bottom clamping jaw is fixed on the bottom end of the flaw-piece clamping jaw mounting column, the top clamping jaw is slidably installed on the upper part of the mounting column, and the top clamping jaw and the bottom clamping jaw are disposed opposite to each other. In this way, the top clamping jaw is capable of moving up and down in the vertical direction, that is, the Z direction of the silicon rod cutting system, so that the distance between the top clamping jaw and the bottom clamping jaw can be adjusted. When the vertical flaw-piece needs to be clamped, the distance between the top clamping jaw and the bottom clamping jaw is adjusted to be greater than the flaw-piece to be clamped at first; then, the bottom clamping jaw bears the lower end face of the flaw-piece to be clamped; next, the top clamping jaw moves downwards in the Z direction until pressing the upper end face of the flaw-piece; and at this time, the flaw-piece has been clamped.

In some embodiments, as shown in FIG. 5A, FIG. 5B, FIG. 5C and FIG. 5D, the flaw-piece clamping frame 51 further includes:
a vertically disposed flaw-piece clamping jaw back plate 513;
a flaw-piece clamping jaw sliding plate 514, wherein the flaw-piece clamping jaw sliding plate 514 is disposed on one plate surface of the flaw-piece clamping jaw back plate 513 and is slidably connected with the flaw-piece clamping jaw back plate 513, the flaw-piece clamping jaw sliding plate is capable of moving in the horizontal direction along the flaw-piece clamping jaw back plate, and the movement direction of the flaw-piece clamping jaw sliding plate is consistent with the X direction of the silicon rod cutting system where the flaw-piece unloading device is located; and
a flaw-piece clamping jaw mounting column fixing plate 515, wherein two opposite end sides of the flaw-piece clamping jaw mounting column fixing plate 515 are respectively fixed with the flaw-piece clamping jaw sliding plate 514 and the flaw-piece clamping jaw mounting column 511, so that the flaw-piece clamping jaw mounting column 511, the flaw-piece clamping jaw mounting column fixing plate 515 and the flaw-piece clamping jaw sliding plate 514 are fixed into a whole; and
the flaw-piece clamping jaw sliding plate 514 moves left and right in the X direction of the silicon rod cutting system, so as to drive the top clamping jaw 512-1 and the bottom clamping jaw 512-2, which are installed on the flaw-piece clamping jaw mounting column 511, to move left and right in the X direction of the silicon rod cutting system.

The flaw-piece clamping jaw mounting column, the flaw-piece clamping jaw mounting column fixing plate and the flaw-piece clamping jaw sliding plate are fixed into a whole and may move left and right in the X direction of the silicon rod cutting system as a whole, so that the top clamping jaw and the bottom clamping jaw, which are installed on the same flaw-piece clamping jaw mounting column, can move left and right in the X direction of the silicon rod cutting system as a whole. In this way, the flaw-piece clamping mechanism can move left and right in the X direction of the silicon rod cutting system, so that the top clamping jaw and the bottom clamping jaw, which are installed on the same flaw-piece clamping jaw mounting column, can be close to the vertical flaw-piece to be clamped in the X direction of the silicon rod cutting system.

In some embodiments, as shown in FIG. 5A, FIG. 5B, FIG. 5C and FIG. 5D, two flaw-piece clamping jaw mounting columns 511 are provided, and the top clamping jaw 512-1 and the bottom clamping jaw 512-2 are installed on the front side of each flaw-piece clamping jaw mounting column 511;
two flaw-piece clamping jaw mounting column fixing plates 515 are provided and are used for respectively fixing one flaw-piece clamping jaw mounting column 511;
two flaw-piece clamping jaw sliding plate 514 are provided and are respectively fixed with one flaw-piece clamping jaw mounting column fixing plate 515,
wherein the front sides of the two flaw-piece clamping jaw mounting columns 511 are disposed opposite to each other.

In this way, since the front sides of the two flaw-piece clamping jaw mounting columns are disposed opposite to each other, the distance between the top clamping jaws and the bottom clamping jaws, which are installed on the two flaw-piece clamping jaw mounting columns, can be adjusted in the X direction of the silicon rod cutting system. In particular, it is applicable to the clamping of two flaw-pieces opposite to each other when the same silicon rod is cut into the square rod.

In some embodiments, as shown in FIG. 5A, FIG. 5B, FIG. 5C and FIG. 5D, the flaw-piece clamping frame 51 further includes:
top clamping jaw Z-direction guide rails 516, wherein each flaw-piece clamping jaw mounting column 511 is provided with two top clamping jaw Z-direction guide rails 516 disposed in parallel; and the guide direction of the top clamping jaw Z-direction guide rails 516 is the vertical direction and is consistent with the Z direction of the silicon rod cutting system;
a top clamping jaw Z-direction sliding block, disposed on the back side of the top clamping jaw 512-1; and
a top clamping jaw Z-direction movement cylinder, fixed at the flaw-piece clamping jaw mounting column 511, wherein a piston rod of the top clamping jaw Z-direction movement cylinder is fixed with the back side of the top clamping jaw; and
the top clamping jaw Z-direction movement cylinder is used for pushing the top clamping jaw 512-1 to move up and down along the top clamping jaw Z-direction guide rails in the vertical direction, that is, the Z direction of the silicon rod cutting system.

In this way, by means of the cooperation among the top clamping jaw Z-direction guide rails, the top clamping jaw Z-direction sliding block and the top clamping jaw Z-direction movement cylinder, the top clamping jaw can move up and down in the vertical direction through a simple structure.

In some embodiments, the flaw-piece clamping frame further includes:
clamping jaw X-direction guide rails, wherein a plate surface of the flaw-piece clamping jaw back plate close to the flaw-piece clamping jaw sliding plate is provided with two clamping jaw X-direction guide rails disposed in parallel; and the guide direction of the clamping jaw X-direction guide rails is consistent with the X direction of the silicon rod cutting system;
a clamping jaw X-direction sliding block, disposed on the plate surface of the flaw-piece clamping jaw sliding plate that is close to the flaw-piece clamping jaw back plate; and
a clamping jaw X-direction movement cylinder, fixed at the flaw-piece clamping jaw back plate, wherein a piston rod of the clamping jaw X-direction movement cylinder is fixed with the flaw-piece clamping jaw sliding plate; and
the clamping jaw X-direction movement cylinder is used for pushing the top clamping jaw sliding plate to move along the clamping jaw X-direction guide rails, so as to drive the top clamping jaw and the bottom clamping jaw, which are installed on one flaw-piece clamping jaw mounting column fixing plate, to be close to or away from, in the X direction, the top clamping jaw and the bottom clamping jaw, which are installed on the other flaw-piece clamping jaw mounting column fixing plate.

In this way, by means of the cooperation among the clamping jaw X-direction guide rails, the clamping jaw X-direction sliding block and the top clamping jaw X-direction movement cylinder, the flaw-piece clamping jaw mounting column fixing plate can move left and right in the X direction of the silicon rod cutting system through a simple structure, and then the top clamping jaw and the bottom clamping jaw, which are installed on one flaw-piece clamping jaw mounting column fixing plate, maybe close to or away from, in the X direction of the silicon rod cutting system, the top clamping jaw and the bottom clamping jaw, which are installed on the other flaw-piece clamping jaw mounting column fixing plate.

In some embodiments, as shown in FIG. 5A, FIG. 5B, FIG. 5C and FIG. 5D, the height of the flaw-piece clamping jaw mounting column fixing plate 515 is less than the height of the flaw-piece clamping jaw mounting column 511, and the height of the flaw-piece clamping jaw back plate 513 is less than the height of the flaw-piece clamping jaw mounting column 511.

The height requirement of the flaw-piece clamping jaw mounting column fixing plate is relatively high, so as to adapt to the flaw-pieces generated by silicon rods of a plurality of heights. In order to reduce the weight and to reduce the materials, the heights of the flaw-piece clamping jaw mounting column fixing plate, the flaw-piece clamping jaw sliding plate and the flaw-piece clamping jaw back plate are all less than the height of the flaw-piece clamping jaw mounting column.

In some embodiments, as shown in FIG. 5A, FIG. 5B, FIG. 5C and FIG. 5D, the flaw-piece clamping jaw mounting column fixing plate 515 is fixed at a middle position of the flaw-piece clamping jaw mounting column 511, and the ratio of the length of the flaw-piece clamping jaw mounting column fixing plate 515 in the Z direction to the height of the flaw-piece clamping jaw mounting column 511 is greater than or equal to one third and less than two thirds.

In this way, the position where the flaw-piece clamping jaw mounting column fixing plate applies a force to the flaw-piece clamping jaw mounting column is at the middle position of the flaw-piece clamping jaw mounting column in the height direction, so that when the flaw-piece clamping mechanism clamps the flaw-pieces generated by silicon rods of a plurality of heights, the clamping is relatively stable, and the flaw-piece clamping jaw mounting column fixing plate is not prone to damage and deformation.

In some embodiments, the flaw-piece clamping jaw mounting column fixing plate is detachably connected with the flaw-piece clamping jaw mounting column and the flaw-piece clamping jaw sliding plate.

The flaw-piece clamping jaw mounting column, the flaw-piece clamping jaw mounting column fixing plate and the flaw-piece clamping jaw sliding plate are fixed in a detachable connection manner by using three components, so that the requirements for manufacturing precision is lower. At the same time, when any component is damaged, for example, when the flaw-piece clamping jaw mounting column fixing plate subjected to a greater downward acting force in the Z direction is damaged, only the damaged component needs to be replaced.

In some embodiments, the flaw-piece clamping mechanism further includes:
a clamping frame movement assembly, fixed with the flaw-piece clamping jaw back plate and installed on the machine base of the silicon rod cutting system, wherein the Y direction of the silicon rod cutting system is vertical to the X direction and the Z direction of the silicon rod cutting system; and
the clamping frame movement assembly is used for driving the clamping frame to linearly reciprocate in three directions, that is, the X direction, the Y direction and the Z direction of the silicon rod cutting system.

In some embodiments, as shown in FIG. 5C, the clamping frame movement assembly includes:
a clamping frame X-direction guide rail 521-1, fixed on an upper surface of the machine base of the silicon rod cutting system, wherein the guide direction of the clamping frame X-direction guide rail is consistent with the X direction of the silicon rod cutting system;
a clamping frame X-direction mounting base 521-2; and
a clamping frame X-direction movement sliding block, fixed on the outer bottom of the clamping frame X-direction mounting base, wherein the clamping frame X-direction movement sliding block cooperates with the clamping frame X-direction guide rail; and
the clamping frame X-direction mounting base is capable of moving along the clamping frame X-direction guide rail in the X direction of the silicon rod cutting system, so as to drive the clamping frame to move in the X direction of the silicon rod cutting system.

In some embodiments, as shown in FIG. 5C, the clamping frame movement assembly includes:
a clamping frame Y-direction mounting base 522;
a clamping frame Y-direction gear rack and a clamping frame Y-direction gear, which are engaged with each other, wherein the clamping frame Y-direction gear rack is fixed on an upper surface of the clamping frame Y-direction mounting base; and the guide direction of the clamping frame Y-direction gear rack is consistent with the Y direction of the silicon rod cutting system, and the clamping frame Y-direction gear is fixed on the outer bottom of the clamping frame Y-direction mounting base.

In some embodiments, as shown in FIG. 5C, the clamping frame movement assembly further includes:
a clamping frame Z-direction mounting base 523; and
a clamping frame Z-direction guide rail lead screw, wherein a nut of the clamping frame Z-direction guide rail lead screw is fixed on the upper surface of the clamping frame Z-direction mounting base; and the guide direction of a guide rail of the clamping frame Z-direction guide rail lead screw is the vertical direction and is consistent with the Z direction of the silicon rod cutting system, and a sliding block of the clamping frame Z-direction guide rail lead screw is fixed at the flaw-piece clamping jaw back plate; and
the clamping frame Z-direction guide rail lead screw is used for converting a received rotational movement into a linear movement along the guide rail of the clamping frame Z-direction guide rail lead screw, and outputting the linear movement by means of the sliding block of the clamping frame Z-direction guide rail lead screw.

In some embodiments, the clamping frame Z-direction guide rail lead screw is driven by a motor.

### Structure of the Flaw-Piece Collection Mechanism 53

In some embodiments, as shown in FIG. 5E, the edge collection mechanism 53 includes: a collection underframe 531;
two groups of flaw-piece boxes, wherein each group of flaw-piece boxes has at least one flaw-piece box 532, and one flaw-piece box is used as one collection area; and
a synchronous reverse flaw-piece box movement assembly, used for driving the two flaw-piece boxes 532 to perform a synchronous reverse movement, wherein the synchronous reverse flaw-piece box movement assembly is fixed on the collection underframe 531, and the two groups of flaw-piece boxes 532 are fixed with the synchronous reverse flaw-piece box movement assembly.

The synchronous reverse flaw-piece box movement assembly is capable of implementing synchronous reverse switching of the two groups of flaw-piece boxes, and thus is convenient to operate; and meanwhile, the two groups of flaw-piece boxes are avoided of being located on the same side to interfere the placement of the flaw-pieces.

In some embodiments, as shown in FIG. 5E, the synchronous reverse flaw-piece box movement assembly includes:
two flaw-piece box guide rails 533-1, fixed on an upper surface of the collection underframe 531 in parallel at intervals; and
two flaw-piece box sliding blocks 533-2, respectively disposed on the outer bottoms of the two groups of flaw-piece boxes 532, wherein the flaw-piece box sliding blocks 533-2 are in sliding fit with the flaw-piece box guide rails 533-1; and
when each group of flaw-piece boxes includes two or more flaw-piece boxes, the flaw-piece boxes in each group of flaw-piece boxes are disposed at interval in the length direction of the flaw-piece box guide rails.

In some embodiments, as shown in FIG. 5E, the synchronous reverse flaw-piece box movement assembly further includes:
a flaw-piece box sliding cylinder 533-3, fixed at the collection underframe 531, wherein a piston rod of the flaw-piece box sliding cylinder 533-3 is fixed with the outer bottoms of the first group of flaw-piece boxes; the first group of flaw-piece boxes is a group of flaw-piece boxes that are fixed with the piston rod of the flaw-piece box sliding cylinder 533-3, and the second group of flaw-piece boxes is a group of flaw-piece boxes that are not fixed with the piston rod of the flaw-piece box sliding cylinder 533-3;
a synchronous wheel 533-4, fixed on the upper surface of the collection underframe 531 and located between the two groups of flaw-piece boxes 532; and
a synchronous belt 533-5, wherein the synchronous belt 533-5 bypasses the synchronous wheel 533-4, and two ends of the synchronous belt 533-5 are respectively fixed with the two groups of flaw-piece boxes 532; and the flaw-piece box sliding cylinder 533-3 is used for pushing the first group of flaw-piece boxes to reciprocate linearly along the flaw-piece box guide rails 533-1, so as to drive the second group of flaw-piece boxes to reciprocate linearly in a reverse direction.

In some embodiments, as shown in FIG. 5E, each flaw-piece box 532 has four flaw-piece storage positions, the four flaw-piece storage positions are disposed in two rows, and the two rows of flaw-piece storage positions are disposed next to each other in the guide direction of the flaw-piece box guide rails.

In some embodiments, as shown in FIG. 5E, one end of each of the two flaw-piece box guide rails is set to be a position where flaw-pieces are to be formed;
the flaw-piece collection mechanism further includes:
a photoelectric rack 534-1, fixed with the collection underframe 531; and
two pairs of storage position correlation photoelectric modules 534-2, disposed in two rows, wherein each pair of storage position correlation photoelectric modules 534-2 is relatively fixed on the photoelectric rack, and the two pairs of storage position correlation photoelectric modules 534-2 are used for detecting whether flaw-pieces are placed on the flaw-piece storage positions of the flaw-piece box located at the position where flaw-pieces are to be formed.

In some embodiments, the four flaw-piece storage positions of the same flaw-piece box are used for carrying four flaw-pieces that are cut away after the same silicon rod is cut into a square rod, so as to encode the four flaw-pieces from the same silicon rod.

What is claimed is:

1. A cutting device of a silicon rod cutting system, comprising:
a support frame, installed on a machine base of the silicon rod cutting system;
two cutting machine head mechanisms, wherein each of the two cutting machine head mechanisms is provided with a diamond wire, a cutting segment of the diamond wire is used for cutting a silicon rod from top to bottom while moving; and
a feeding mechanism, wherein the support frame is connected with the two cutting machine head mechanisms by means of the feeding mechanism, and the two cutting segments are disposed opposite to each other;
wherein the feeding mechanism is used for driving the two cutting machine head mechanisms to move towards and away from each other, so as to adjust the distance between the two cutting segments, and the feeding mechanism is further used for driving the two cutting machine head mechanisms to move up and down in a vertical direction, so as to cut and reset a vertically disposed silicon rod.

2. The cutting device as claimed in claim 1, wherein each of the two cutting machine head mechanisms comprises a wire saw assembly, and the wire saw assembly comprises:
a wire saw mounting rack, provided with a machine head through hole which extends in vertically; and
the diamond wire, disposed on a front side of the wire saw mounting rack, wherein the cutting segment and the machine head through hole do not interfere with each other;
wherein the machine head through hole is used for taking out flaw-pieces formed by cutting the silicon rod.

3. The cutting device as claimed in claim 1, comprising a silicon rod chuck mechanism, wherein the silicon rod chuck mechanism comprises:
a chuck rack;
an upper floating head, installed at the chuck rack, wherein the chuck rack is capable of moving up and down, and the upper floating head is used for pressing an upper end face of the silicon rod vertically placed; and
a flaw-piece holding rack, connected with the chuck rack and capable of extending out downwards and resetting upwards, wherein the flaw-piece holding rack is used for extending out downwards and holding a peripheral surface of the silicon rod, and the flaw-piece holding rack is further used for resetting upwards to leave the peripheral surface of the silicon rod.

4. The cutting device as claimed in claim 3, wherein the flaw-piece holding rack comprises:
a flaw-piece holding rack mounting member, fixed with the chuck rack;
a holding rod fixing member and a flaw-piece holding rod, wherein the flaw-piece holding rod is fixed on a side of the holding rod fixing member that is away from the upper floating head and extends out downwards; and
a flaw-piece holding driving device, connected with the flaw-piece holding rack mounting member and the holding rod fixing member respectively, and used for driving the holding rod fixing member and the flaw-piece holding rod to extend out downwards and reset upwards.

5. The cutting device as claimed in claim 3, further comprising a silicon rod supporting mechanism, wherein the silicon rod supporting mechanism comprises:
a silicon rod supporting mounting base; and
a lower floating head, used for supporting a lower end face of the silicon rod vertically placed, wherein the lower floating head is installed above the silicon rod supporting mounting base.

6. The cutting device as claimed in claim 5, wherein the silicon rod supporting mechanism further comprises a flaw-piece supporting assembly, and the flaw-piece supporting assembly comprises:
a flaw-piece supporting driving device, fixed on the silicon rod supporting mounting base and spaced apart from the lower floating head;
a flaw-piece supporting head, used for supporting a position where the lower end face of the silicon rod is cut to form flaw-pieces, wherein the flaw-piece supporting head is fixed on a top end of the flaw-piece supporting driving device; and the flaw-piece supporting driving device is used for locking when the silicon rod is cut into a square rod and flaw-pieces, so that the flaw-piece supporting head keeps the height to support the flaw-pieces.

7. The cutting device as claimed in claim 6, wherein the silicon rod supporting mechanism further comprises a silicon rod rotating assembly, and the silicon rod rotating assembly comprises:
a silicon rod rotating shaft, wherein the lower floating head is fixed on the silicon rod rotating shaft, and the silicon rod rotating shaft is rotationally connected above the silicon rod supporting mounting base; and
a silicon rod driving motor, fixed below the silicon rod supporting mounting base, and connected with the silicon rod rotating shaft so as to drive the silicon rod rotating shaft to rotate.

8. The cutting device as claimed in claim 1, wherein the feeding mechanism comprises:
two transverse feeding mechanisms, wherein the two transverse feeding mechanisms and the two cutting machine head mechanisms are disposed in a one-to-one correspondingly manner, wherein a cutting machine head mechanism is fixed with a corresponding transverse feeding mechanism, the cutting segments of the two cutting machine head mechanisms are disposed opposite to each other, and the transverse feeding mechanisms are installed with the support frame; and the two transverse feeding mechanisms are used for driving the two cutting machine head mechanisms to move close to and away from each other, and adjusting a distance between the cutting segments of the two cutting machine head mechanisms of the cutting device;
two vertical feeding mechanisms, wherein the two vertical feeding mechanisms and the two transverse feeding mechanisms are disposed in a one-to-one correspondingly manner, and the two vertical feeding mechanisms vertically fixed on a same side of the support frame respectively, wherein a transverse feeding mechanisms is fixed on a corresponding vertical feeding mechanism; and the two vertical feeding mechanisms are used for driving the two transverse feeding mechanisms to move in the vertical direction respectively, so as to drive the two cutting machine head mechanisms to move in the vertical direction; and
a feeding control unit, used for controlling the two transverse feeding mechanisms so as to adjust the distance between the two cutting segments, and also used for controlling the two vertical feeding mechanisms so as to adjust a movement of the two cutting machine head mechanisms in the vertical direction.

9. The cutting device as claimed in claim 2, wherein each of the two cutting machine head mechanisms further comprises:
a cleaning assembly, fixed on the front side of the wire saw mounting rack,
wherein the cleaning assembly is provided with a plurality of cleaning nozzles, the cleaning nozzles of the cleaning assembly comprise a first part of cleaning nozzles for cleaning a cutting machine head mechanism disposed at an opposite-side and a cutting machine head mechanism disposed at a present-side, and a second part of cleaning nozzles for cleaning the cutting machine head mechanism disposed at an opposite-side; and
a spray assembly, fixed on the front side of the wire saw mounting rack,
wherein the spray assembly is provided with a spray head for spraying cutting fluid to the silicon rod and a cutting seam formed by cutting the silicon rod via an annular diamond wire, and performing cooling.

10. The cutting device as claimed in claim 9, wherein the wire saw assembly further comprises:
a driving wheel assembly and a lower transition wheel, respectively disposed on the front side of the wire saw mounting rack and located on two sides of the machine head through hole;
a tension wheel assembly and an upper transition wheel, respectively disposed on the front side of the wire saw mounting rack;
wherein the diamond wire is an annular diamond wire, which is twined on peripheral surfaces of a driving wheel of the driving wheel assembly, the lower transition wheel, a tension wheel of the tension wheel assembly and the upper transition wheel, the cutting segments are formed on bottom ends of the driving wheel and the lower transition wheel, and the diamond wire and the machine head through hole do not interfere with each other.

11. A silicon rod cutting system, comprising:
the cutting device according to claim 1;
a flaw-piece clamping mechanism;
a flaw-piece collection mechanism, wherein the flaw-piece collection mechanism has collection areas, and the collection areas and the cutting stations of the silicon rod cutting system are disposed in a one-to-one correspondingly manner; and
a collection control unit, used for controlling the flaw-piece clamping mechanism to clamp flaw-pieces generated by the cut silicon rod from each cutting station of the silicon rod cutting system and to convey and place the flaw-pieces in the flaw-piece collection mechanism, and the flaw-pieces generated by cutting a same silicon rod are placed in a same collection area.

12. The silicon rod cutting system as claimed in claim 11, wherein the flaw-piece clamping mechanism comprises a flaw-piece clamping frame, and the flaw-piece clamping frame comprises:
a flaw-piece clamping jaw mounting column; and
a top clamping jaw and a bottom clamping jaw, installed on the front side of the flaw-piece clamping jaw mounting column and disposed up and down opposite to each other,
wherein at least one of the top clamping jaw and the bottom clamping jaw is slidably connected with the flaw-piece clamping jaw mounting column and is capable of moving up and down in the vertical direction, and a side of the flaw-piece clamping jaw mounting column on which the top clamping jaw and the bottom clamping jaw are installed is the front side.

13. The silicon rod cutting system as claimed in claim 12, wherein the bottom clamping jaw is fixed on a bottom end of the flaw-piece clamping jaw mounting column; and
the top clamping jaw is slidably connected with the flaw-piece clamping jaw mounting column, and the top clamping jaw is capable of moving up and down in the vertical direction.

14. The silicon rod cutting system as claimed in claim 11, further comprising a feeding and blanking device, wherein the feeding and blanking device comprises a round rod feeding assembly, and the round rod feeding assembly comprises:
a round rod feeding rack, wherein the round rod feeding rack is L-shaped;
the feeding and blanking device further comprises:
a feeding and blanking support frame, wherein the round rod feeding rack is rotatably connected with the feeding and blanking support frame;
a feeding turnover driving device, respectively fixed with a bottom of the feeding and blanking support frame and an outer bottom of the round rod feeding rack, wherein the feeding turnover driving device is used for driving the round rod feeding rack to turn over by 90 degrees from an initial position of the round rod feeding rack; and
a feeding processing unit, used for controlling the feeding turnover driving device so as to control the round rod feeding rack to first accelerate in turning over, and when the round rod feeding rack turns over by a preset angle, reducing a turnover speed of the round rod feeding rack until the round rod feeding rack turns over by 90 degrees.

15. The silicon rod cutting system as claimed in claim 11, further comprising a transfer device, wherein the transfer device comprises:
a feeding and blanking clamping jaw frame;
an upper clamping jaw assembly and a lower clamping jaw assembly, installed on a same side of the feeding and blanking clamping jaw frame in parallel at intervals up and down; and
a transfer driving assembly, used for driving the upper clamping jaw assembly to move relative to the lower clamping jaw assembly up and down in a height direction of the feeding and blanking clamping jaw frame, and is further used for driving the upper clamping jaw assembly and the lower clamping jaw assembly to move up and down synchronously.

16. The silicon rod cutting system as claimed in claim 11, wherein the edge collection mechanism comprises:
a collection underframe;
two groups of flaw-piece boxes, wherein each of the two groups of flaw-piece boxes has at least one flaw-piece box; and
a synchronous reverse flaw-piece box movement assembly, used for driving the two groups of flaw-piece boxes to perform a synchronous reverse movement, wherein the synchronous reverse flaw-piece box movement assembly is fixed on the collection underframe, and the two groups of flaw-piece boxes are fixed with the synchronous reverse flaw-piece box movement assembly.

17. The silicon rod cutting system as claimed in claim 11, wherein each of the two cutting machine head mechanisms comprises a wire saw assembly, and the wire saw assembly comprises:
a wire saw mounting rack, provided with a machine head through hole which extends in vertically; and
the diamond wire, disposed on a front side of the wire saw mounting rack, wherein the cutting segment and the machine head through hole do not interfere with each other;
wherein the machine head through hole is used for taking out flaw-pieces formed by cutting the silicon rod.

18. The silicon rod cutting system as claimed in claim 11, comprising a silicon rod chuck mechanism, wherein the silicon rod chuck mechanism comprises:
a chuck rack;
an upper floating head, installed at the chuck rack, wherein the chuck rack is capable of moving up and down, and the upper floating head is used for pressing an upper end face of the silicon rod vertically placed; and
a flaw-piece holding rack, connected with the chuck rack and capable of extending out downwards and resetting upwards, wherein the flaw-piece holding rack is used for extending out downwards and holding a peripheral surface of the silicon rod, and the flaw-piece holding rack is further used for resetting upwards to leave the peripheral surface of the silicon rod.

19. The silicon rod cutting system as claimed in claim 11, wherein the feeding mechanism comprises:
two transverse feeding mechanisms, wherein the two transverse feeding mechanisms and the two cutting machine head mechanisms are disposed in a one-to-one correspondingly manner, wherein a cutting machine head mechanism is fixed with a corresponding transverse feeding mechanism, the cutting segments of the two cutting machine head mechanisms are disposed opposite to each other, and the transverse feeding mechanisms are installed with the support frame; and the two transverse feeding mechanisms are used for driving the two cutting machine head mechanisms to move close to and away from each other, and adjusting a distance between the cutting segments of the two cutting machine head mechanisms of the cutting device;
two vertical feeding mechanisms, wherein the two vertical feeding mechanisms and the two transverse feeding mechanisms are disposed in a one-to-one correspondingly manner, and the two vertical feeding mechanisms vertically fixed on a same side of the support frame respectively, wherein a transverse feeding mechanisms is fixed on a corresponding vertical feeding mechanism; and the two vertical feeding mechanisms are used for driving the two transverse feeding mechanisms to move in the vertical direction respectively, so as to drive the two cutting machine head mechanisms to move in the vertical direction; and
a feeding control unit, used for controlling the two transverse feeding mechanisms so as to adjust the distance between the two cutting segments, and also used for controlling the two vertical feeding mechanisms so as to adjust a movement of the two cutting machine head mechanisms in the vertical direction.

20. The silicon rod cutting system as claimed in claim 17, wherein each of the two cutting machine head mechanisms further comprises:
a cleaning assembly, fixed on the front side of the wire saw mounting rack,
wherein the cleaning assembly is provided with a plurality of cleaning nozzles, the cleaning nozzles of the cleaning assembly comprise a first part of cleaning nozzles for cleaning a cutting machine head mechanism disposed at an opposite-side and a cutting machine head mechanism disposed at a present-side, and a second part of cleaning nozzles for cleaning the cutting machine head mechanism disposed at an opposite-side; and
a spray assembly, fixed on the front side of the wire saw mounting rack,
wherein the spray assembly is provided with a spray head for spraying cutting fluid to the silicon rod and a cutting seam formed by cutting the silicon rod via an annular diamond wire, and performing cooling.
